(19) United States
(12) Patent Application Publication
(10) Pub. No.: US 2024/0406138 A1
(43) Pub. Date: Dec. 5, 2024

(54) Compact Network Cyber Device

(71) Applicant: Science Applications International Corporation, Reston, VA (US)

(72) Inventor: Frank L. James, III, Manassas, VA (US)

(21) Appl. No.: 18/204,692

(22) Filed: Jun. 1, 2023

(51) Int. Cl. H04L 9/40

(52) U.S. Cl. CPC H04L 63/0227; H04L 63/20

(57) ABSTRACT

A compact network cyber device may be configured to receive data frames from a network, process the received data frames based on one or more classification rules, and transmit at least a portion of those data frames back to the network. The device may comprise a wireless interface configured to transmit data based on processing of the data frames and to receive data that may comprise rules and/or other configuration instructions for the device.

### GOVERNMENT LICENSE RIGHTS

This invention was made with government support under Contract No. HQ08452390001 awarded by the United States Government Defense Innovation Unit. The government has certain rights in this invention.

### BACKGROUND

Data networks operated by corporations, businesses, governmental units, and other enterprises are under constant threat. Threats may come from external and/or internal sources. External sources may include malicious actors attempting to infiltrate a network. Internal sources may include users who are authorized to access an enterprise's network, but who may attempt to access network resources outside the scope of their authorization, or who may inadvertently or maliciously introduce malware. To detect internal or external threats, data traffic in a network may be monitored.

### SUMMARY

This Summary is provided to introduce a selection of some concepts in a simplified form as a prelude to the Detailed Description. This Summary is not intended to identify key or essential features.

A network cyber device may be configured to receive data frames from a network or from a host network device, compare one or more portions of the received data frames to criteria of classification rules, and based upon an action transmit some or all of the received data frames via the other of the network or the host network device. For data frames determined to match one or more criteria of classification rules, the device may be configured to take additional action such as blocking a data frame, modifying a data frame, generating and sending additional data frames, performing machine learning or other analysis, and/or other actions. The device may comprise a wireless interface and may be further configured to transmit, via that wireless interface, copies of data frames that matched classification rule criteria, additional data regarding those matching data frames, and/or other data (e.g., network traffic analysis data). The device may be compact in size, may have low power requirements, and may be unobtrusively installed in a network. The device may have a size and hardware interfaces that allow the device to be installed in a host network device receptacle that is configured to receive a pluggable transceiver module.

These and other features are described in more detail below.

### BRIEF DESCRIPTION OF THE DRAWINGS

Some features are shown by way of example, and not by way of limitation, in the figures of the accompanying drawings and in which like reference numerals refer to similar elements.

FIG. 1 is a block diagram showing an example compact network cyber device.

FIG. 2 is a block diagram showing an example software architecture associated with a compact network cyber device such as the device of FIG. 1.

FIGS. 3A, 3B, 3C, and 3D are diagrams showing examples of how frames may be processed by a DSP array of the processor shown in FIG. 1

FIG. 4 is a diagram showing arrangement of elements in a DSP array.

FIG. 5 is a block diagram showing an example compact network cyber device, such as the device of FIG. 1, configured for use with optical data cables.

FIG. 6 is a block diagram showing an example compact network cyber device, such as the device of FIG. 1, configured for use with electrical data cables.

FIG. 7 is a floor plan for an example SoC that may be used in a compact network cyber device such as the device of FIG. 1.

FIG. 8 is a block diagram showing an example compact network cyber device, such as the device of FIG. 1, that comprises a monolithic MCM package.

FIG. 9 is a block diagram showing an example compact network cyber device, such as the device of FIG. 1, that comprises a stacked MCM package.

FIG. 10A shows another example compact network cyber device, such as the device of FIG. 1, in the form of a CFSP device or CQFSP device configured for installation as pluggable module in a host network device.

FIG. 10B shows additional details of the CFSP device or CQFSP device of FIG. 10A.

FIG. 11 is a flow chart showing an example method for processing a received data frame.

FIGS. 12A, 12B, 12C, and 12D are sequence diagrams showing example operations performed by a compact network cyber device.

### DETAILED DESCRIPTION

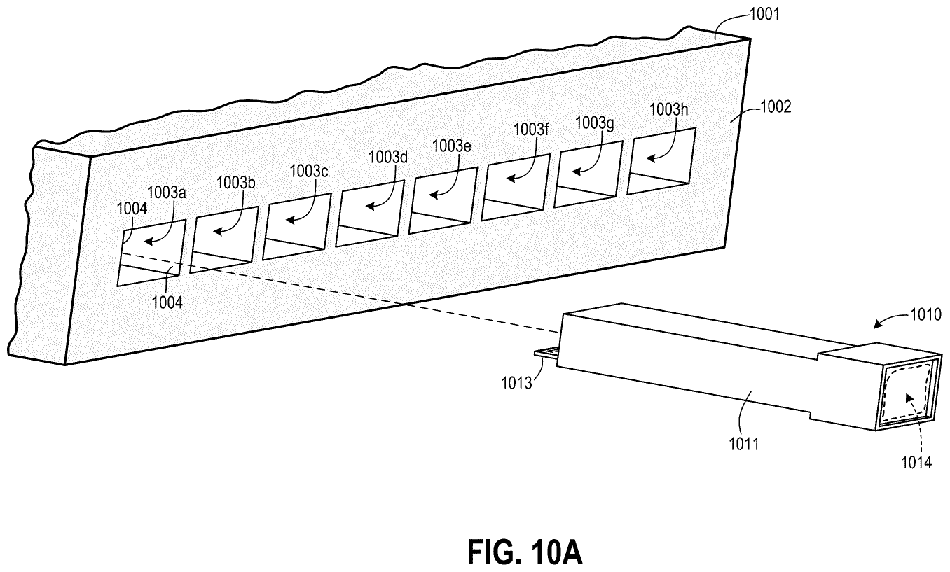

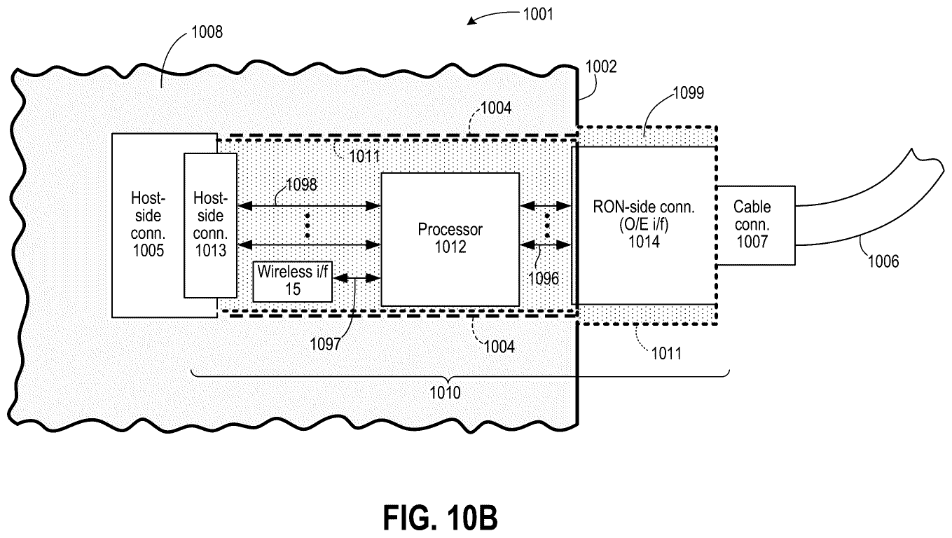

Described herein are examples of compact network cyber devices that may be installed in a network and that may be used to monitor, analyze, and/or take action with regard to data traffic. The described devices comprise pluggable cyber devices that may be installed in numerous network devices (e.g., switches, routers, firewalls, etc.) and that may be used to analyze Ethernet frames at Layer 2 and/or Layer 3 in a network. As discussed below in connection with FIGS. 10A and 10B, such pluggable cyber devices comprise devices that may be referred to herein as Cyber Small Form-factor Pluggable (CSFP) devices and Cyber Quad Small Form-factor Pluggable (CQSFP) devices. Pluggable cyber devices may monitor data frames and may perform actions such as block, modify, transmit, learn, and/or record monitored data frames based upon one or more data classification rules. Pluggable cyber devices may be configured to perform one or more actions indicated by or otherwise associated with one or more rules. As described in more detail below, such actions may comprise blocking/filtering, transmitting, and/or recording of data frames, may comprise generating and injecting data frames, may comprise network pattern recognition and/or other analysis, and/or may comprise sending reports of cyber actions executed based on rules.

Compact network cyber devices described herein may be compact in size and may have low power requirements. In addition to monitoring network data traffic and/or executing actions regarding such traffic based on rules, these cyber devices may communicate OOB, relative to a monitored network, to receive instructions and/or to provide reports based on network monitoring. These characteristics facilitate unobtrusive and/or concealed installation of such devices throughout a network, as well as monitoring of the network (and taking action regarding monitored data traffic) without significant (or any) impact on network performance.

For convenience, set forth below is a list of initialisms, acronyms, and/or abbreviations used throughout this disclosure. Other initialisms, acronyms, and/or abbreviations may also be introduced throughout this disclosure.
ADC Analog to Digital Converter
AES Advanced Encryption Standard
AI Artificial Intelligence
ANSI American National Standards Institute
AP Access Point
API Application Programming Interface
ARP Address Resolution Protocol
C2C Chip to Chip
CMOS Complementary Metal Oxide Semiconductor
CSMA/CA Carrier Sense Multiple Access and Collision Avoidance
CSMA/CD Carrier Sense Multiple Access and Collision Detection
CSP Chip Scale Package
DAC Digital to Analog Converter
DAP Debug Access Port
DBSCAN Density Based Spatial Clustering Applications with
Noise
DCF Distributed Coordination Function
DDR Double Data Rate
DIFS Distributed Inter-Frame Space
DSP Digital Stream Processor
DTIM Delivery Traffic Indication Message
FIFO First In First Out
Gbps Gigabits per second
GPIO General Purpose Input/Output
GPP General Purpose Processor
gRPC Google Remote Procedure Call
IEEE Institute of Electrical and Electronics Engineers
I²C Inter-Integrated Circuit Protocol
IP Internet Protocol
IPv4 Internet Protocol version 4
JTAG Joint Test Action Group
LBT Listen Before Talk
LLC Link Layer Control
LPP Low Power Processor
MAC Media Access Control
MCM MultiChip Module
ML Machine Learning
mm millimeter
MPLS MultiProtocol Label Switch
NaaS Network as a Service
NAV Network Allocation Vector
NIDS Network Intrusion Detection System
nm nanometer
O/E Optical/Electrical
OOB Out-of-Band
PCB Printed Circuit Board
PCF Point Coordination Function
PHY Physical Layer
PLL Phased-Locked Loop
QoS Quality of Service
QSFP Quad Small Form-factor Pluggable
QSPI Quad Serial Peripheral Interface
RON Rest of Network
RPC Remote Procedure Call
SERDES Serializer/Deserializer
SD Secure Digital
SFD Start Frame Delimiter
SFP Small Form-factor Pluggable
SiP Silicon in Package
SNAP Subnetwork Access Protocol
SNMP Simple Network Management Protocol
SPI Serial Peripheral Interface
SoC System on a Chip
TLS Transport Layer Security
TCP Transmission Control Protocol
UART Universal Asynchronous Receiver-Transmitter
UCIe Universal Chiplet Interconnect Express
UDP User Datagram Protocol
VLAN Virtual Local Area Network
WAN Wide Area Network

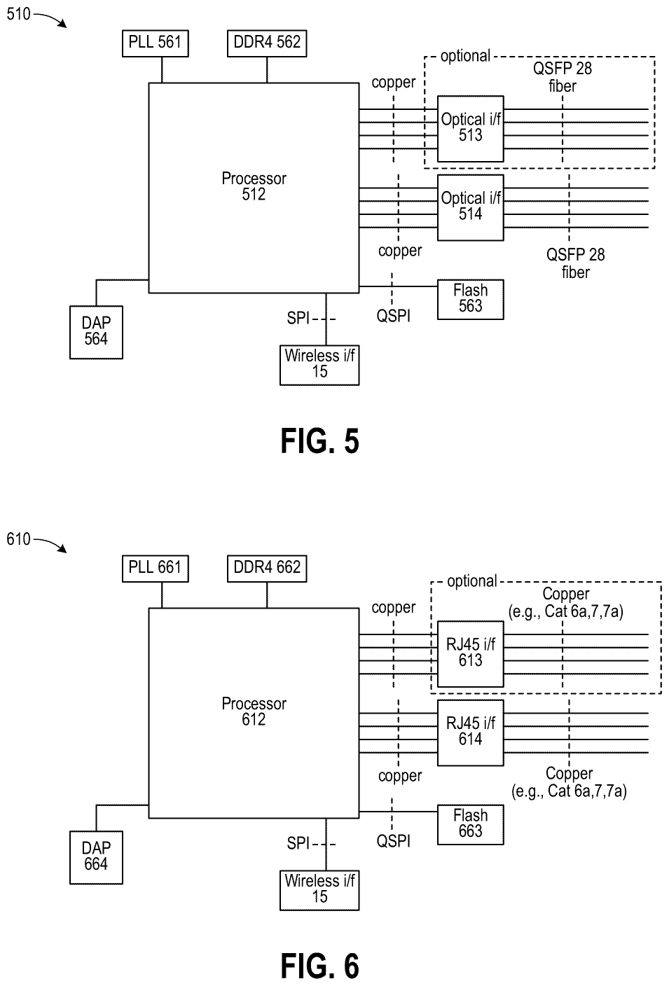

FIG. 1 is a block diagram showing an example compact network cyber device 10. Device 10 generically represents any of the example compact network cyber devices described herein (e.g., any of the devices 510, 610, 810, 910, or 1010 of FIGS. 5, 6, 8, 9, 10A and 10B). The device 10 may comprise a housing 11 that holds a processor 12, which generically represents any of the processors described herein (e.g., any of the processors 512, 612, 712, 812, 912, or 1012 of FIGS. 5, 6, 7, 8, 9, 10A, and 10B). The processor 12 may comprise multiple processors, memory for storing instructions and/or other data, and/or other components, and may comprise (or be comprised by) a SoC, SiP, or an MCM. The device 10 may further comprise a host-side connector (conn.) 13, a RON-side connector 14, a wireless interface (i/f) 15, and a Flash interface 16. The host-side connector 13, which generically represents any of the multiple host-side connectors described herein (e.g., any of the connectors 513, 613, 813, 913, or 1013 of FIGS. 5, 6, 8, 9, 10A, and 10B), may be configured to connect with a mating connector 18 of a network host computing device (e.g., a network client device, a server, switch, a router, a firewall), or with a connector of a cable connected to a network host computing device. The RON-side connector 14, which generically represents any of the multiple RON-side connectors described herein (e.g., any of the connectors 514, 614, 814, 914, 1014 of FIGS. 5, 6, 8, 9, 10A, and 10B), may be configured to connect with a mating connector 19 of the cable that links the network host computing device with the network. The interface between the connectors 13 and 18, and/or between the connectors 14 and 19, may be electrical (e.g., an RJ45 connection, a connection between an edge connector and an edge connector receptacle mounted on a PCB of a switch or other network device, or other type of electrical connection). The interface between the connectors 13 and 18, and/or between the connectors 14 and 19, may be optical (e.g., an Ethernet 100 Gbps connection). For an optical interface, the connector 13 and/or the connector 14 may comprise O/E circuitry to convert optical signals received from the network to electrical signals forwarded to the processor 12, and/or to convert electrical signals from the processor 12 to optical signals for transmission to the network.

The processor 12 may be configured (e.g., by instructions stored in memory) to perform (and/or to cause the device 10 to perform) operations described herein. Those operations may comprise receiving data via a receiving connector (e.g., one of the host-side connector 13 or the RON-side connector 14), monitoring that data based on one or more classification rule sets, and taking action based on that monitoring and one or more rules of the rule set(s). The action may comprise forwarding that data via a transmitting connector (e.g., the other of the host-side connector 13 or the RON-side connector 14), generating and transmitting frames via the transmitting connector, blocking frames, modifying frames, storing frames, machine learning and/or other analysis, and/or other actions. The operations performed by the processor 12 may also comprise generating and sending data (e.g., monitoring reports, copies of frames determined to match rule criteria) via the wireless interface 15, receiving data via the wireless interface 15, and/or other operations described herein.

The wireless interface 15 may comprise a chip, SoC, MCM, SiP, or chipset configured to wirelessly communicate data via one or more wireless communication protocols and to provide a management plane secondary data path. The wireless communications via the wireless interface 15 may comprise wireless communications according to one or more IEEE 802.11 standards (e.g., 802.11 b/g/n and/or other WiFi communications), wireless communications according to one or more BLUETOOTH specifications of the Bluetooth Special Interest Group (e.g., BLUETOOTH or BLUETOOTH LOW ENERGY (BLE) communications), and/or one or more other types of wireless communications.

The processor 12, the wireless interface 15, the flash interface 16, the host-side connector 13, and the RON-side connector 14 may be attached to a PCB or other substrate (not shown in FIG. 1) and contained, in whole or in part, in the housing 11. The housing 11 may, for example, have a size of approximately 5 inches by 4 inches by 1 inch. Any or all of these dimensions may be significantly smaller. For example, the processor 12, the wireless interface 15, the flash interface 16, and/or other components may be contained in a silicon package (e.g., having a size of approximately 10 mm by approximately 10 mm by approximately 3.5 mm), and as described below in connection with FIGS. 10A and 10B, a housing 1011 of a compact network cyber device 1010 may be sized to fit within a host network device receptacle configured to receive a pluggable transceiver module having dimensions and hardware interfaces defined by one or more standards.

The processor 12 may comprise a low power DSP such as, for example, one of various types of low power DSPs used in mass-produced consumer product electronics. For example, the processor 12 may comprise a 12 nm LPP/DSP SoC from Global Foundries. The DSP may have the ability to encrypt and/or decrypt (e.g., decrypt software loaded to the processor from Flash memory) using an AES algorithm. This may prevent violation of a security chain of trust during startup. The processor 12 may comprise a DSP processor in combination with chiplets or monolithically combined components configured to perform one or more other operations (e.g., providing/controlling an Ethernet MAC interface, providing/controlling an Ethernet PHY interface, PLL operations, providing clock and/or oscillator signals, die-to-die communication, GPP core and peripheral operations, ADC/DAC, DDR memory and memory control, encryption/security, etc.).

The processor 12 may be configured to perform 1/10/100 Gbps Ethernet MAC and PHY operations to enable monitoring and other processing of data frames, as described in more detail herein. The processor 12 may be configured to ignore nuisance frames such as switch spanning tree and routing control frames using Ethernet MAC and PHY functions, enabling the processor 12 to perform efficient, deep packet inspection on application and cyber specific network frames. The processor 12 may comprise an Ethernet interface capability that may be used for passive monitoring, frame processing, and active packet injection to apply cyber defense and/or offense as required for a network being monitored. This Ethernet interface capability may operate in promiscuous mode (e.g., monitoring all frames transmitted on a medium regardless of destination address).

Because Ethernet technology uses CSMA/CD, frames may be visible to all devices on a medium. If a placement of the device 10 is such that a frame cannot be blocked from reaching the rest of the network, other techniques may be used to defeat the threat to network stacks targeted by a malicious frame. For example, a frame could be generated and injected to notify a destination computer of the threat and/or to interrupt IP flow to cause the destination stack to discard the frame (e.g., to cause a TCP flow close/reset) and/or inject HTML or other data into a TCP/IP stream. If the malicious frame carries a TCP/IP or a UDP/IP packet, a duplicate frame may be constructed with modified information and injected to cause an IP stack to ignore the previously received frame. Even if a frame is not blocked, the intended effect of the malicious frame may be disrupted by forcing a reset of the TCP/IP communication path.

L2 and L3 inspection may be based on some or all of 5-tuple fields of IP packets in Ethernet frames (source IP address, source port, destination IP address, destination port, transport protocol), based on other fields of such IP packets, and/or based on other fields of an Ethernet frame (e.g., destination MAC address, source MAC address, EtherType, LLC, SNAP, Length, VLAN ID, MPLS ID, etc.). These fields may, for example, be analyzed to determine vendor information, network patterns, the most active applications being used by users, and/or to evaluate threats based upon suspicious IP packets that are derived from IP packets originating from IP networks external to an enterprise. IP flow sequence numbers may be recorded for the purpose of creating new frames to be injected into IP flows and/or responding to IPv4 requests on behalf of the host. This information may also be reported via the wireless OOB channel, which facilitates AI/ML algorithms to perform analysis such as user behavior, nefarious behavior, and identify inside/external network threats.

The processor 12 may be configured to categorize network frame traffic based upon spatial and temporal correlation techniques. For example, on Friday personnel may be expected to update timesheets, which may correspond to an expected increase in traffic towards a timesheet management server during that time period. Based on that knowledge, the processor 12 may be dynamically configured (alone or in concert with other network equipment) to adjust QoS to enable higher performance for timesheet activity towards a specific application IP port number or server IP address during this time period. As another example, it may be known that personnel in a particular spatial location should not access specific applications. Those personnel may therefore be blocked from the use of those applications within a spatial/geographic location by configuring the processor 12 to inject and/or block frames to prevent successful IP communication between relevant clients and servers.

The processor 12 may be configured to perform adaptive algorithms that learn IP traffic flows by monitoring network traffic passing through the device 10, and that report anomalies if new or unknown traffic patterns are detected. Such adaptive algorithms may be used, for example, to detect tamper events, adversaries, cyber threats, etc. at Layer 2 and/or Layer 3. The anomalies may be reported (e.g., via the wireless interface 15) to a NaaS, to a cyber protection service, and/or to network management tools for evaluation. The transmit windows of the wireless interface 15 may be limited so as to reduce a probability of detection of network monitoring by the device 10.

A wireless network used by the wireless interface 15 may be maintained as a separate IP domain that is entirely different from, and that can be disguised and/or hidden from, a wired IP domain monitored by the device 10. Additionally, that wireless IP domain may be defined based upon spatial location. A wireless management IP domain for the device 10 may be protected and made private by using a VLAN, MPLS tags, etc.

NaaS, Cyber, and network management tools may be used to query, configure, and/or control multiple devices 10 that may be deployed throughout a network of an enterprise or organization. One or more devices 10 may be used to collect information, apply temporal and/or spatial correlation (e.g., based on L2 and/or based on 5-tuple (and/or other) fields in IP packets at L3), collect network and/or application statistics, apply AI/ML to network frames in real-time, and/or perform other operations.

As indicated above, the compact size of the device 10 facilitates a low-profile deployment strategy that can be easily hidden from view. The processor 12 may comprise a DSP that enables software development of network algorithms that do not require intense hardware knowledge, but that instead can be based on the ANSI C language well-known processor programming skills. The device 10 may be integrated with known network and/or cyber management protocols (e.g., SNMP). The device 10 may be integrated, via the wireless interface 15, with cloud services and/or cloud applications to facilitate software defined networking, programmable networking, API-based operation, and WAN services (e.g., transport, hybrid cloud, multi-cloud, Private Network Interconnect and Internet Exchanges through NaaS control and configuration). Deployment of multiple devices 10 may facilitate the application of AI/ML to a monitored network in real time to observe and respond to network behaviors representative of cyber-attacks, as well as to detect network anomalies based upon learned behaviors. Applications on wireless-enabled handheld devices such as smart phones, tablets, etc. may be used to locate, based on data from multiple devices 10 in a network, malfunctioning switches, routers, or other elements to more quickly pinpoint network performance bottlenecks and problems.

As indicated above, the wireless interface 15 may comprise a chip or chipset that facilitates wireless communications using one or more wireless protocols (e.g., WiFi communications, BLUETOOTH communications, BLUETOOTH Low Energy (BLE) communications, etc.). Examples of chips that may be used as the wireless interface 15 comprise the RS9116 family of wireless transceiver module SoCs available from Silicon Laboratories Inc. The wireless interface 15 may be used to provide a management and reporting interface for the device 10 and may be configured to provide OOB management, reporting, and/or other applications with a secure TCP and TLS connection, via an AP, to a cloud application enabling software defined networking, programmable networking, API-based operation, and WAN services (e.g., transport, hybrid cloud, multi-cloud, Private Network Interconnect and Internet Exchanges through NaaS control and configuration).

The wireless interface 15 may be configured for low power operation and/or to reduce operation time so that that windows of communication detection are minimized. The wireless interface 15 may be configured to support CSMA/CA and use LBT operation with a binary exponential backoff algorithm (e.g., DCF). The DCF may use both physical and virtual sensing of a medium. A physical carrier sense may utilize energy detection and/or preamble/header detection. A virtual carrier sense may utilize time duration information found in a frame, as well as NAV information. There may be three timing intervals for the DCF, while PCF may utilize two timing intervals.

When using DCF, the wireless interface 15 may check to determine if a NAV is clear and ensure there is no activity on the PHY. If both NAV and PHY are clear, the wireless interface 15 may listen for a DIFS time period. If no activity is detected after the DIFS time period, the wireless interface 15 may transmit. Otherwise, the wireless interface 15 may backoff and double the contention window (CW) and try again. PCF, an optional technique used to prevent collisions in IEEE 802.11-based communications, may be used with or instead of DCF. A DTIM setting for an AP may impact how frequently a connected wireless interface 15 will wake up and thus, may impact power consumption. A higher DTIM setting corresponds to a longer period between wake-up packets, thus higher DTIM means longer battery life and/or less power draw. An AP configured to manage and/or otherwise communicate with one or more devices 10 may be configured with an appropriate DTIM interval that balances timing response with power draw. This approach may be used in conjunction with SNMP messages sent via the wireless network.

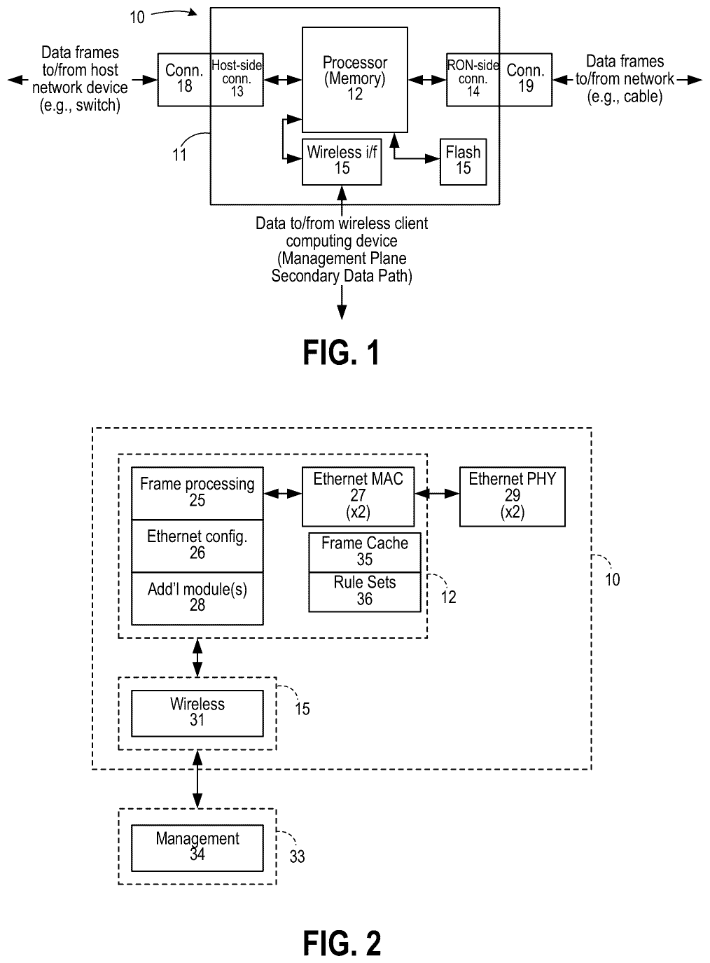

FIG. 2 is a block diagram showing an example software architecture associated with the compact network cyber device 10. The processor 12 may store and execute frame processing software 25, Ethernet configuration software 26, and Ethernet MAC software 27, and may further store and execute one or more additional types of software 28. Ethernet PHY software 29 may (e.g., for electrical data communications) be stored and executed by a separate chip or by the processor 25. Also, or alternatively (e.g., for optical data communications), Ethernet PHY software may be stored and executed by the host-side connector 13 (e.g., if that connector is an optical cable connector with O/E conversion circuitry) or the RON-side connector 14 (e.g., if that connector is an optical cable connector with O/E conversion circuitry). Although only one block is shown for Ethernet MAC 27 and Ethernet PHY 29, there may be two Ethernet MAC software modules 27 and two Ethernet PHY software modules 29 (e.g., to accommodate duplex communication). When available, signal detection of autonegotiation may occur on the RON side of the device 10 to prevent a rate differential between the RON and the host device. A frame cache 35 may cache frame templates that are used to inject frames and/or frames to be reported upon, and a rule set memory 36 may store one or more classification rule sets. Wireless communication software 31 may be stored and executed by the wireless interface 15. A client computing device 33, which may comprise a smart phone, a tablet, a notebook or laptop computer, or other computing device, may comprise a wireless interface and be configured to communicate wirelessly with the processor 12 via the wireless interface 15, and may further store and execute management software 34 that is used to manage, configure, and collect data from the device 10. The management software 34 may comprise a rule API via which input may be provided to specify parameters for classification rules, as well as a compiler configured to receive that input and create compiled rule tables for those classification rules based on that input. The compiled rule tables may then be transmitted, via the wireless interface 15, to the processor 12 for storage and execution.

The rule API may receive text-based grammar input to specify monitoring parameters (e.g., protocol(s), source address(es), source port(s), destination address(es), destination port(s), direction, etc.), actions to perform if values of monitoring parameters are matched, and other options. The rule API (or a portion thereof) language semantics may be based on the open-source NIDS known as SNORT, based on another NIDS, and/or otherwise configured to generate executable rule tables based on user input via one or more APIs. The rule API may be modified to support monitoring of Layer 2 network frame fields such as source MAC address, destination MAC address, EtherType, SNAP, Length, and LLC (if available). The Layer 2 modification may include a new semantic definition referred to as “eth” which enables match criteria for the Layer 2 network frame fields.

A classification rule may comprise one or more criteria based on the monitoring parameters specified for the rule. Each of the one or more criteria may comprise a value, or a range of values, for a monitoring parameter. For example, rule criteria may comprise values (or ranges of values) for one or more specified IP packet fields (e.g., one or more fields of an IP packet 5-tuple), values (or ranges of values) for one of more specified Ethernet fields (e.g., destination MAC address, source MAC address, EtherType, LLC, SNAP, Length, VLAN ID, MPLS ID, etc.), values (or ranges of values) for time/date associated with a data frame, and/or values (or ranges of values) for other parameters. A data frame may match a classification rule with multiple criteria if values of monitoring parameters (e.g., field values) for that data frame are the same as, or are within range(s) specified by, criteria of the rule. A data frame may match a classification rule with a single criterion if a value of a monitoring parameter for that data frame is the same as, or is within a range specified by, the criterion of the rule. A classification rule may also comprise, indicate, or otherwise be associated with one or more actions to be taken with regard to a data frame determined to have matched the one or more criteria of the rule. Table 1 lists examples of actions that a rule may comprise, indicate, or otherwise be associated with; a classification rule may comprise, indicate, or otherwise be associated with multiple actions.

TABLE 1
Cyber Classification Rule Actions

| | Description of Action Taken if Frame Matches One or |
|---|---|
| Action | More Rule Criteria for Layer 2 and/or Layer 3 |
| Allow | Transmit matched frame from the device 10 via connector |
| | other than connector via which matched frame was received |
| | (e.g., transmit via the host-side connector 13 if matched |
| | frame received via the RON-side connector 14, transmit |
| | via the RON-side connector 14 if matched frame received |
| | via the host-side connector 13) |
| Block | Prevent matched frame from being transmitted from the |
| | device 10 |
| Replace | Transmit, via connector other than connector via which |
| | matched frame was received, and instead of the matched |
| | frame, a modified frame (e.g., if Modify action also |
| | specified) or another frame different from the matched frame |
| Relay | Send the matched frame, via the wireless interface 15, to |
| | management software or other external destination, or |
| | transmit the matched frame, via the monitored network, to |
| | a destination different from destination indicated in |
| | matched frame |
| Inject | Inject (e.g., transmit via connector other than connector via |
| | which matched frame was received) one or more frames as |
| | a response to match; injected frame(s) may be generated new |
| | frame(s) or modified version(s) of matched frame(s); |
| | generated new frame(s) may be generated based on |
| | template(s) indicated by classification rule with one or more |
| | matched criteria; injectedframe(s) may be transmitted in |
| | addition to (e.g., if Allow action also specified), or instead |
| | of (e.g., if Replace action also specified), matched frame |
| Whitelist | Allow matched frame, and subsequent frames having same |
| | source and/or destination parameters, to pass without |
| | inspection |
| Modify | Modify matched frame (e.g., modify values in one or more |
| | fields) and transmit modified frame via connector other |
| | than connector via which matched frame was received; |
| | modified frame may be transmitted instead of matched |
| | frame (e.g., if Replace action also specified) or in addition |
| | to matched frame (e.g., if Allow action also specified) |
| Blacklist | Prevent matched frame, and subsequent frames having |
| | same source and/or destination parameters, from passing |
| Ignore | Allow matched frame to pass without inspection |
| Learn | Apply one or more specified ML/AI or other algorithms to |
| | frame (e.g., to determine, identify, classify, etc., data traffic |
| | patterns/characteristics) |

Cyber classification rules may be parsed, verified, and compiled by the management software 34. When compiled, rule tables for classification rules may comprise one or more hash indexes that can be used for high speed frame processing by a DSP array of the processor 12. The processor 12 may implement an RPC client (e.g., a gRPC client) that communicates with the management software 34 via the wireless interface 15 to receive files comprising the compiled rule tables. The wireless interface 15 may forward those files, via an SPI of the DSP array, for storage in memory (e.g., in rule sets memory 36). The configuration of the rules can be applied as a special packet that is forwarded to the DSP in order of precedence from earliest rule+action to last rule+action. This may prevent rules from being applied out of order and creating unpredictable results.

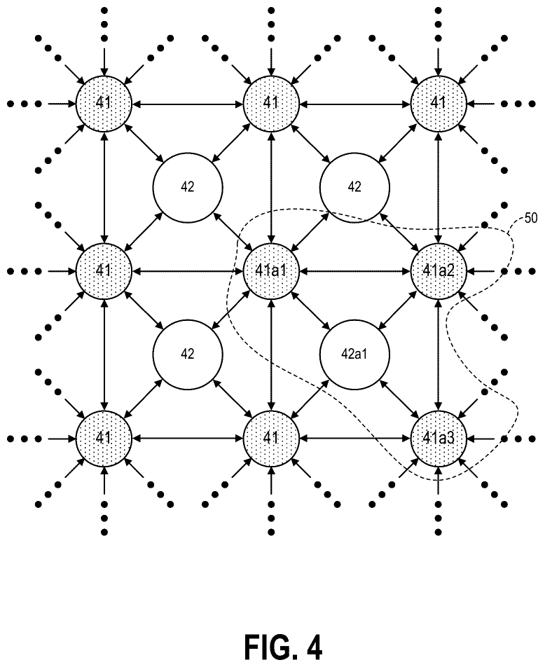

As explained in more detail below in connection with FIG. 4, the processor 12 may comprise a SoC in which a DSP core comprises a mesh of DSP processing elements interlaced with a mesh of data memory router (memory/router) elements. An example of such a SoC is the HYPERX HX40416 SoC available from Coherent Logix, Inc. The processing elements may perform computational operations and the memory/router elements may store instructions and/or data associated with those computations. Use of such an array allows parallel processing of frames and execution of chained classification rules.

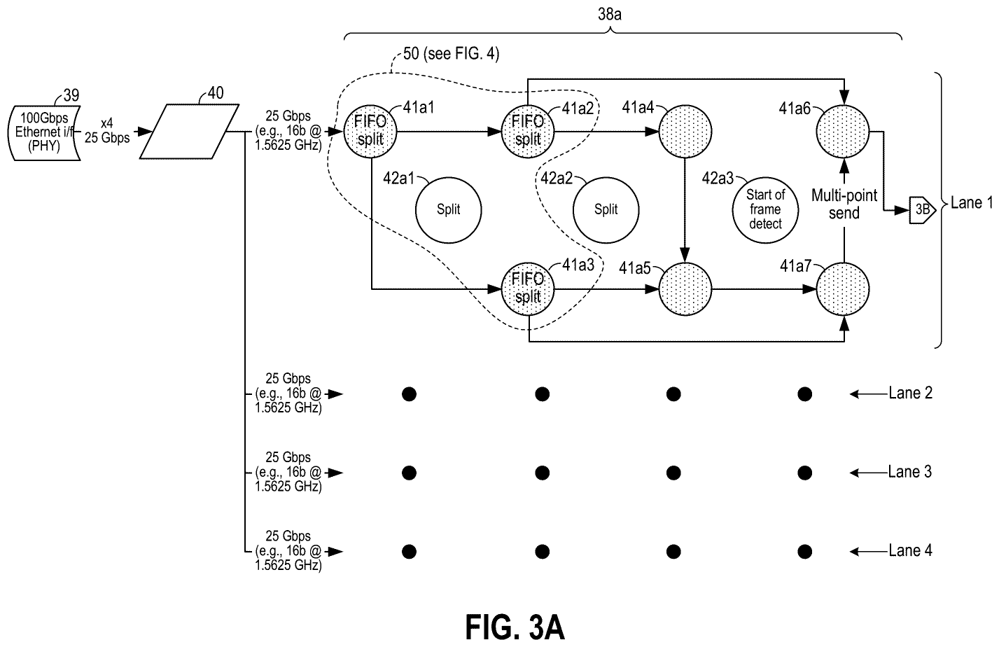

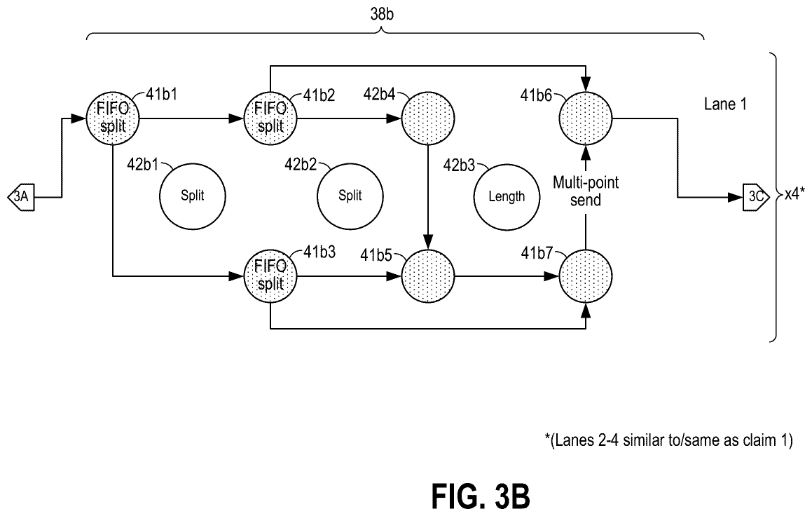

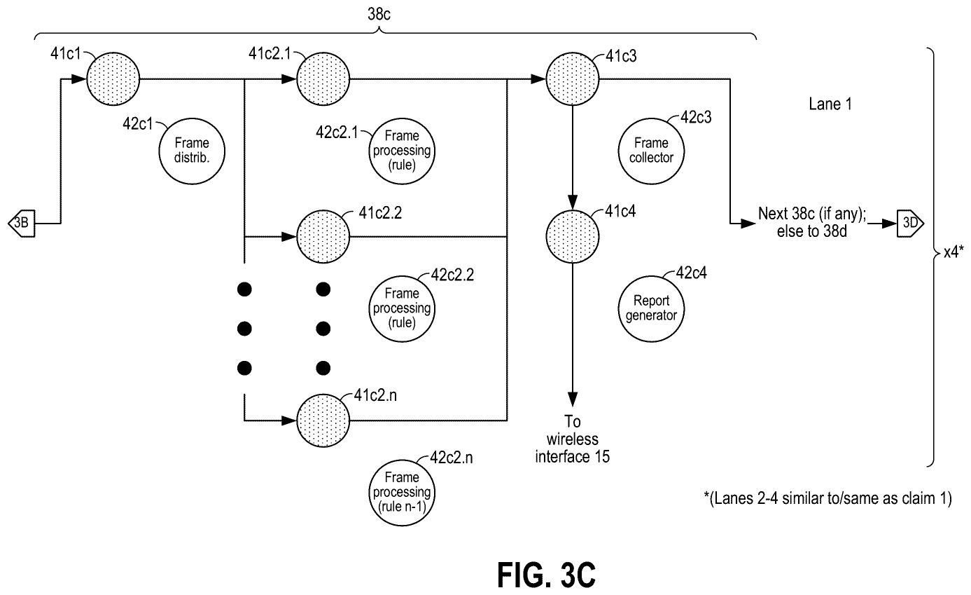

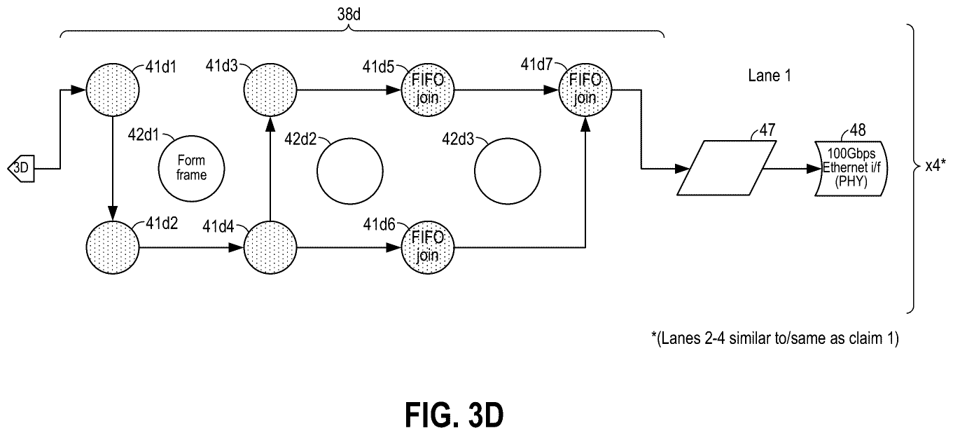

FIGS. 3A through 3D are diagrams showing examples of how 100 Gbps Ethernet frames may be processed by a DSP array of the processor 12. As shown at block 39, an optical 100 Gbps Ethernet signal, which may comprise four 25 Gbps channels, may be received by the device 10 via an Ethernet PHY interface and converted to four corresponding electrical 25 Gbps data streams. The optical 100 Gbps signal may be received via the host-side connector 13 or the RON-side connector 14. As shown at block 40, each of the 25 Gbps data streams is directed to a separate lane of processing elements and memory/routing elements of the DSP array. For convenience, FIGS. 3A-3D only show details of Lane 1 corresponding to one of the 25 Gbps streams. However, the details for each of Lanes 2, 3, and 4, corresponding to the other three Gbps streams and processing in parallel with Lane 1, may be the same as Lane 1. Also, the device 10 may be configured to operate in full duplex mode, and the elements shown in FIGS. 3A through 3D may be repeated for each of four additional lanes associated with data traffic in an opposite direction. For example, the processor 12 may comprises the elements of FIGS. 3A through 3D, together with similar elements for 3 additional lanes, for parallel processing of data traffic from the network to the host device, and may further comprise elements similar to those of FIGS. 3A through 3D for 4 additional lanes for parallel processing data traffic from the host device to the network.

In FIGS. 3A through 3D, memory/routing elements are indicated with smaller stippled circles and are generically numbered 41 (with specific elements 41 having additional references letters and numbers appended). Processing elements are indicated with larger unstippled circles and are generically numbered 42 (with specific elements 42 having additional references letters and numbers appended). FIG. 4 shows the how elements 41 and elements 42 may be arranged in the DSP array, as well as the relationship of the portion 50 of the DSP array (indicated in FIGS. 3A and 4 with a broken line) to other elements 41 and elements 42 in the DSP array.

As shown in FIG. 4, each of the elements 42 is surrounded by four elements 41. As indicated by double-sided arrows connecting each of the elements 42 with its four surrounding elements 41, each of the elements 42 is able to communicate with those surrounding four elements 41. Such communications may comprise retrieving instructions or other data from an element 41, storing data to an element 41, or instructing an element 41 (e.g., to forward data to another element 41). As indicated by double-sided arrows connecting each of the elements 41 to its four adjacent elements 41, each of the elements 41 is able to route data to any of those adjacent elements 41. As indicated by the arrows with ellipses, the pattern of elements 41 and 42 may extend throughout the DSP array.

Returning to FIG. 3A, a processing sequence 38a may be performed to detect a beginning of an Ethernet frame. An Ethernet frame may begin with a preamble consisting of seven bytes with a value “10101010,” followed by a 1-byte SFD having a value of “10101011.” Thus, a start of an Ethernet frame may be detected by detecting the 8-byte sequence “10101010 10101010 10101010 10101010 10101010 10101010 10101010 10101011.” As indicated above, the processing sequence 38a may be performed in parallel in four separate lanes 1-4. The frame structure may also or alternatively be determined by a combination of EtherType and Ethernet length fields (if present) and/or IP header length (if available). Also, or alternatively, the frame structure can be derived by determining the end of frame by iteratively calculating the FCS and comparing the next four (4) bytes to detect the FCS at the end of the frame.

For each lane, at the beginning of the processing sequence 38a, each successive 8-byte portion of the 25 Gbps data stream may, after storage in element 41a1 and in a FIFO manner, and based on instructions from element 42a1, be split into first and second 4-byte portions that are respectively routed to elements 41a2 and 41a3. The second 4-byte portion routed from element 41a1 to element 41a3 may be routed via the element 41a2 or via another element 41 that is not shown. After storage in element 41a2 and in a FIFO manner, and based on instructions from element 42a2, the first 4-byte portion may be split into two 2-byte portion portions that are respectively routed to elements 41a4 and 41a6. The 2-byte portion routed from element 41a2 to element 41a6 may be routed via the element 41a4 or via another element 41 that is not shown. Similarly, after storage in element 41a3, in a FIFO manner, and based on instructions from element 42a2, the second 4-byte portion may be split into two 2-byte portions that are respectively routed to elements 41a5 and 41a7. The 2-byte portion routed from element 41a3 to element 41a7 may be routed via the element 41a5 or via another element 41 that is not shown. After the four 2-byte portions are stored by elements 41a4 through 41a7, the element 42a3 may check to determine whether those four 2-byte portions contain the above-noted sequence that indicates a frame start.

After element 42a3 checks the four 2-byte portions stored in elements 41a4 through 41a7, those 2-byte portions may be transmitted (in their original order as received by the element 41a1) to elements 41 and 42 that will perform the processing sequence 38b in FIG. 3B. If the element 42a3 determines that a beginning of a frame has been detected, the element 42a3 may add data to the data stream of the frame (e.g., immediately following the SFD byte) to mark the beginning of the frame. That marker data may be removed during subsequent processing before the frame exits the DSP array.

FIG. 3B shows a processing sequence 38b that may be performed to detect an end of an Ethernet frame. An end of an Ethernet frame may be indicated by a signal frame from the Ethernet PHY. Also, or alternatively, the end of the frame may be determined based on frame length (e.g., based on the frame length field of the frame). As indicated above, the processing sequence 38b may be performed in parallel in four separate lanes 1-4. For each lane, at the beginning of the processing sequence 38b, each successive 8-byte portion of the 25 Gbps data stream may, after storage in element 41b1 and in a FIFO manner, and based on instructions from element 42b1, be split into first and second 4-byte portions that are respectively routed to elements 41b2 and 41b3. The second 4-byte portion routed from element 41b1 to element 41b3 may be routed via the element 41b2 or via another element 41 that is not shown. After storage in element 41b2 and in a FIFO manner, and based on instructions from element 42b2, the first 4-byte portion may be split into two 2-byte portion portions that are respectively routed to elements 41b4 and 41b6. The 2-byte portion routed from element 41b2 to element 41b6 may be routed via the element 41b4 or via another element 41 that is not shown. Similarly, after storage in element 41b3, in a FIFO manner, and based on instructions from element 42b2, the second 4-byte portion may be split into two 2-byte portions that are respectively routed to elements 41b5 and 41b7. The 2-byte portion routed from element 41b3 to element 41b7 may be routed via the element 41b5 or via another element 41 that is not shown. After the four 2-byte portions are stored by elements 41b4 through 41b7, the element 42b3 may check to determine whether those four 2-byte portions contain data that indicates a frame end.

After element 42b3 checks the frame length portions stored in elements 41b4 through 41b7, those portions may be transmitted (in their original order as received by the element 41a1) to elements 41 and 42 that will perform the processing sequence 38c in FIG. 3C. If the element 42b3 determines that an end of a frame has been detected, the element 42b3 may add data 2 bytes in size to the beginning of the data stream of the frame (e.g., immediately following the last byte of the frame) to mark the end of the frame. That marker data may be removed during subsequent processing before the frame exits the DSP array.

FIG. 3C shows a processing sequence 38c that may be performed to apply a classification rule to multiple frames. The classification rule may be a classification rule previously input via the wireless interface 15, as described above. As indicated above, the processing sequence 38c may be performed in parallel in four separate lanes 1-4. If the processor 12 has been configured to apply multiple classification rules to each frame, the processing sequence 38c may be serially performed (in each of four separate lanes) for each of those multiple classification rules.

As one or more frames, and/or one or more portions of frames, are stored by the 41c1, the element 42c1 causes (based on added start and end of frame markers) frames in the data stream to be distributed to and stored in elements 41c2.1 through 41c2.n, where n may be any positive integer value. Each of the elements 41c2.1 through 41c2.n may store a different frame from the data stream, thereby allowing each of elements 42c2.1 through 42c2.n to apply a rule to those frames in parallel. Based on applying the rule, each of the elements 42c2.1 through 42c2.n may determine whether the frame stored in a corresponding one of elements 41c2.1 through 41c2.n has matched to one or more criteria of the rule. If no match is determined, the frame may be forwarded to the element 41c3 unmodified. If a match is determined, the frame may be forwarded to the element 41c3 together with a marker indicating the match.

After receipt by the element 41c3, and if there is another rule to be applied, the element 42c3 causes the frames to be transmitted, in the order those frames were received in the original data stream, to elements 41 and 42 that will repeat the first portion of the process 38c based on the next rule. If there is not another rule to be applied, the element 42c3 causes the frames to be transmitted to elements 41 and 42 that will perform the processing sequence 38d in FIG. 3D.

The element 42c3 may also determine, for each of the frames received by 41c6, whether there is a marker indicating a match to the rule. If such a marker is detected, the element 42c3 may cause a copy of the frame to be sent to the element 41c4. Based on configuration or request, the element 42c4 may cause a copy of the that frame to be saved for later transmission, via the wireless interface 15, to the management software 34 of the client 33 (FIG. 2). Based on configuration or request, the element 42c4 may also generate, and cause to be sent with (or instead of) the copy of the frame, report data. The report data may indicate the rule matched, may indicate an action executed (or to be executed) based on the match, and/or may comprise other data relating to the frame. Depending on the action specified by the rule, the element 42c4 may prevent (and/or may signal one or more other elements 42 to prevent) a frame matching the rule from being forward to the next instantiation of the sequence 38c or to the sequence 38d (e.g., if the rule requires a Block action). Also, or alternatively, and depending on the action specified by the rule, the element 42c4 may generate (and/or may signal one or more other elements 42 to generate) a new frame and cause that new frame to be sent, with (or instead of) the frame that matched the rule, to the next instantiation of the sequence 38c or to the sequence 38d (e.g., if the rule required an Inject action). Also, or alternatively, and depending on the action specified by the rule, the element 42c4 may modify (and/or may signal one or more other elements 42 to modify) a frame that matched the rule and may cause that modified frame to be sent (instead of or with the original frame) to the next instantiation of the sequence 38c or to the sequence 38d.

FIG. 3C shows a single element 41 and a single element 42 associated with each instance of applying a rule to a frame. However, there may be multiple elements 41 (e.g., additional elements 41 adjacent to an element 42) associated with each instance of applying a rule to a frame. For example, if a frame cannot be stored in a single element 41 (e.g., because the frame is long and/or because storage space in the elements 41 is needed to store instructions and/or frame injection templates associated with a rule), portions of the frame may be stored in different elements 41. Similarly, there may be more than one element 42 associated with each instance of application of a rule to a frame. For example, a rule may be applied in multiple steps.

As can be appreciated from the above, rule matching may be implemented in blocks of elements 41 and 42 to determine state machine match operations. This rule matching may then determine the state of the rule sets that are applied. Rule memory and instruction memory may coexist in the same memory space in elements 41 for ease of execution and reduction of instructions required to execute each rule comparison. Each of two 2 pipelines on each element 42 may be used on each clock, reducing the number of clocks required to perform the match operation. Blocks may be used to execute any chained set of actions, which may execute serially, before being transferred to the final operations to be applied to the output FIFO in the processing sequence 38d. Frame operations can be applied serially, building upon previous operations that have modified the content of the frame. In this way, a set of rules can be used to perform a set of operations that are dependent upon both the frame content and the previous frame operations.

FIG. 3D shows a processing sequence 38d that may be performed to assemble a data frame into an outbound FIFO buffer 47 (or internal memory FIFO) for transmission via a channel of the 100 Gbps Ethernet PHY 48, and that may be performed using elements 41d1 through 41d7 and elements 42d1 through 42d3 (and/or other elements 41 and/or 42). A final operation may include actions that were identified earlier and may include modification and injection operations which require access to memory for the specified action to be performed. This portion of the processing may also implement a density based spatial and temporal learning Al/ML algorithm such as DBSCAN. In each stage the frame check sequence may be calculated. Additionally, attributes of the frame may be recorded in memory based on Layer 2 and/or Layer 3 frame fields so that they may later be evaluated based upon temporal and/or quantity analyses (e.g., using DBSCAN). As indicated above, the processing sequence 38d may be performed in parallel in four separate lanes 1-4, in each direction, to support full duplex operation.

At the conclusion of the processing sequence 38d, the DSP array may cause the frames to be transmitted via Ethernet MAC and PHY interfaces and one of the connectors 13 or 14. For example, if the host-side connector 13 was the incoming connector (e.g., the device 10 received the Ethernet signal via the host-side connector 13), the RON-side connector 14 may be the outgoing connector (e.g., the frames may be transmitted from the device 10 via the RON-side connector 14). If the RON-side connector 14 was the incoming connector, the host-side connector 13 may be the outgoing connector. As indicated above, either of the connectors 13 or 14 may comprise an optical interface. If the outgoing connector comprises an optical interface, the outgoing Ethernet frames may be converted to an optical signal as part of the Ethernet PHY interface associated with the outgoing connector. Each connector may support full duplex operation.

As explained above, the device 10 may be configured to operate in full duplex. For example, a set of elements 41 and 42 may be configured to perform the processing sequences 38a-38d on frames received via the host-side connector 13 and transmitted via the RON-side connector 14, and another set of elements 41 and 42 may be configured to perform the processing sequences 38a-38d on frames received via the RON-side connector 14 and transmitted via the host-side connector 13. The connectors 13 and 14 may be configured to allow duplex operation, and/or the there may be multiple connectors 13 and/or connectors 14, and/or multiple Ethernet MAC and PHY interfaces, configured for duplex operation.

The wireless communication software 31 (FIG. 2), which may comprise instructions stored in memory of the wireless interface 15, may configure the wireless interface for communication via one or more wireless communication protocols, and may also interface with the processor 12 to send data and/or instructions to the processor 12 (e.g., data received via a wireless communication) and to receive data from the processor 12 (e.g., data for transmission via a wireless communication). The wireless interface 15 may be an ultra-low power wireless interface that may be configurable to sleep for desired periods of time to conserve power. The wireless communication software 31 may place the wireless interface 15 in a connected sleep mode. In this sleep mode, the wireless interface 15 may go to sleep based on a GPIO message from the DSP array. A processor handshake, via a GPIO message from the DSP array, may be sent to wake the wireless interface 15 before data is sent (e.g., via an SPI interface) to the wireless device 15 for transmission.

One or more Ethernet MAC and/or PHY interfaces of the device 10 (e.g., associated with the connector 13 and/or the connector 14) may also be configurable based on instructions sent, via the wireless interface 15, from the management software 34 to the processor 12. For example, a MAC address, a speed (e.g., 10 Gbps, 100 Gbps), a drive strength, and/or a port configuration of an Ethernet interface may be configured in this way. Also, or alternatively, one or more aspects of an Ethernet configuration may be performed in other ways (e.g., a MAC address may be learned through an ARP packet (e.g., Request, Response, Gratuitous) or gratuitous ARP speed configuration, pulses on the Ethernet interface may be used to learn the speed of the Ethernet interface). Based on information determined from the RON interface, MAC address and speed may be configured on the host interface. Instructions to configure an Ethernet interface may, for example, be received by a DSP array of the processor 12, from the wireless interface 15 and via an SPI and/or I²C interface of the DSP array.

FIG. 5 is a block diagram showing an example compact network cyber device 510 configured for use with optical data cables. Unless indicated otherwise, features described in connection with the compact network cyber device 10 may also apply to the device 510. The device 510 may comprise a SoC in which a DSP core comprises mesh of DSP processing elements interlaced with a mesh of memory/router elements (e.g., the HYPERX HX40416 SoC described above). The device 510 may further comprise a host-side optical connector 513 and a RON-side optical connector 514, each of which may comprise a QSFP 28 compatible optical interface for conversion of optical signals to electrical signals and vice versa. Optionally, the RON-side optical connector 514 may comprise an ultra-compact CSP optical connector. The device 510 may further comprise a programmable PLL chip 561, a DDR (e.g., DDR4) memory chip 562, a separate Flash memory chip 563, and a DAP 564. The Flash memory 563 may connect to the processor 512 via a QSPI interface. The wireless interface 15 may connect to the processor 512 via an SPI interface. The programmable PLL chip 561 may be included, for debug purposes, to adjust (e.g., reduce) a clock speed of the processor 512 to reduce power. The DAP 564 may be included to enable debug of firmware. The DDR4 memory 562 may be used as a packet buffer for frame storage. One or more of the PLL chip 561, the DDR4 memory chip 562, the Flash memory chip 563, and/or the DAP 564 may be omitted.

GPIO interfaces on the processor 512 may be used to drive an I²C interface on a PHY chiplet of the processor 512 to configure the Ethernet PHY speeds and power for copper (described below in connections with FIG. 6), QSFP and SFP configurations. High speed SERDES interfaces of the processor 512 may be used to transmit and receive data (e.g., Ethernet frames) to and from the DSP processor array. The processor 512 may be configured to drive an SPI to I²C conversion to configure modules of the optical interfaces (associated with the connectors 513 and (CSP) 514) through an I²C interface. This I²C interface may be used to reduce the drive strength of the SERDES module and turn off unneeded bidirectional ports (e.g., to reduce power). This configuration can be accomplished dynamically, but with the unneeded ports turned off immediately during startup.

The device 512 may be booted for debugging either through the encrypted DAP 564 or through code loaded via the QSPI port from flash. Debug capability may also include an ability to boot from an SD card (e.g., Flash memory 563). High speed frames may be received via an incoming Ethernet port associated with one of the connectors 513 or (CSP) 514. High speed frames may be transmitted via an outgoing Ethernet port associated with the other of the connectors 513 or (CSP) 514. Each Ethernet port may comprise four copper traces that can operate for any of 2.5G, 5G, 10G, or 25G speeds that interface through a SERDES interface. All four copper traces may operate at 25G (×4) to achieve 100 Gbps. For debug or other purposes, the DDR4 memory 562 may be used for saving selected frames of interest. Also, or alternatively, selected frames of interest may be forwarded via wireless interface 15 to the client 33 and management software 34.

FIG. 6 is a block diagram showing an example compact network cyber device 610 configured for use with copper Ethernet cables. Unless indicated otherwise, features described in connection with the compact network cyber device 10 may also apply to the device 610. The device 610 comprises a processor 612, a DDR4 memory 662, a Flash memory 663, and a DAP 664 that may respectively be similar to the processor 512, the DDR4 memory 562, the Flash memory 563, and the DAP 564 of the device 510. The device 610 may operate similar to the device 510, except that the device 610 comprises, instead of the optical connectors 513 and 514 and corresponding optical interfaces, RJ45 ports for the host-side connector 613 and for the RON-side connector 614.

Although FIG. 5 shows an example compact network cyber device in which both host-side and RON-side connectors are optical connectors, and FIG. 6 shows an example compact network cyber device in which both host-side and RON-side connectors are electrical connectors, connectors of a compact network cyber device need not be of the same type. For example, a compact network cyber device such as the device 10, the device 510, the device 610, or the device 1010 (described below) may comprise an electrical host-side connector and an optical RON-side connector, or may comprise an optical host-side connector and an electrical RON-side connector.

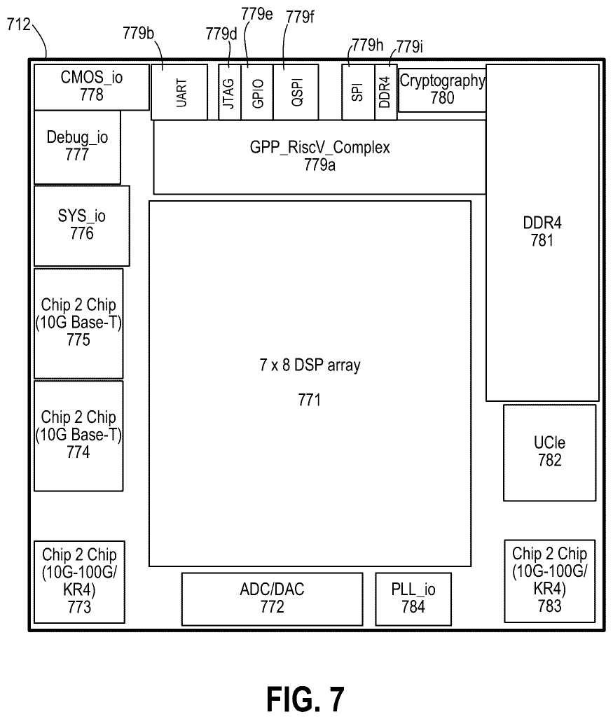

FIG. 7 is a diagram showing a floor plan for an example SoC processor 712 that may be used as the processor 12 in the compact network cyber device 10 or as a processor in other compact network cyber devices described herein. The processor 712 may have a 10 mm×10 mm package size, with a 1.2 mm gap between die and package edge. An example technology node that may be used is the Global Foundries 12 nm LP+. The processor 712 may comprise a 7×8 DSP array 771 (e.g., a HyperX DSP processor array), Ethernet interface C2C chiplets 773 and 783 (e.g., based on 10G-100G Ethernet KR4 C2C controllers from Alphawave IP Group PLC and/or Synopsys, Inc.), Ethernet interface C2C chiplets 774 and 775 (e.g., based on 10G Base-T Ethernet interface chips/chiplets from Alphawave IP Group PLC and/or Synopsys, Inc.), system input/output circuitry 776; debug input/output circuitry 777; CMOS (e.g., RAM) input/output circuitry 778; a GPP RISC-V complex 779a; a UART 779b; JTAG circuitry 779d; GPIO circuitry 779e; QSPI circuitry 779f; SPI circuitry 779h; DDR4 779i; a cryptography chiplet 780 (e.g., based on root of trust/security chips/chiplets from Intrinsic ID, Inc.), DDR4 memory and controller 781 (e.g., based on DDR4 chips/chiplets from Synopsys, Inc.), UCIe circuitry 782; a PLL section 784 (e.g., based on PLL chips/chiplets from Analog Bits, Inc., True Circuits Inc., and/or Silicon Creations, L.L.C.), and an ADC/DAC section 772 (e.g., based on chips/chiplets from Jariet Technologies, Inc. and/or IQ Analog). The GPP RISC-V complex 779a may be physically placed in a location that enables a wideband high sample rate ADC/DAC to be placed closer to the DSP Array 771. This design concept reduces the distance between the high speed JESD204B compliant ADC/DAC block and the DSP Array 771 and reduces the impedance in regard to the analog input of the wideband ADC/DAC 772. Alternatively, the wideband high sample rate ADC/DAC 772 may be interchanged with a wireless controller that supports wireless communications according to one or more IEEE 802.11, Bluetooth, and/or other standards.

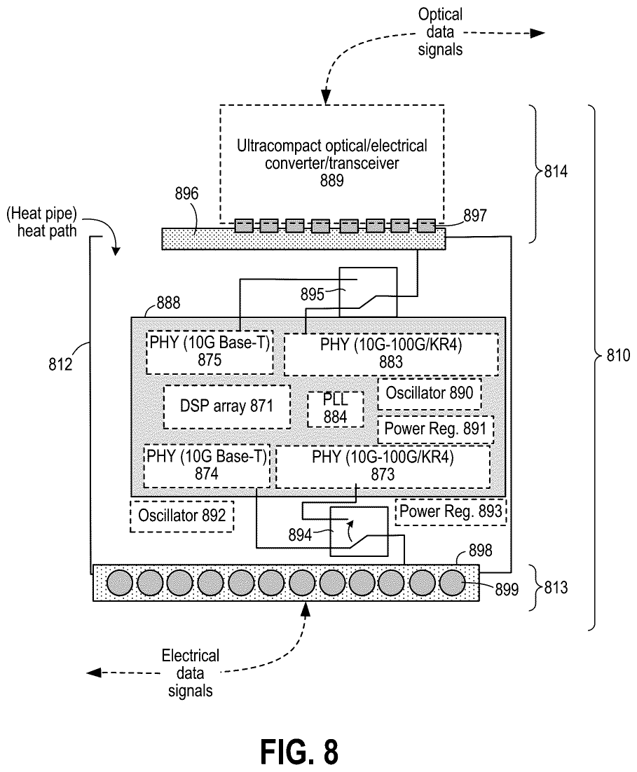

FIG. 8 is a block diagram showing an example compact network cyber device 810 that comprises a monolithic MCM package 812, and that has the ability to switch between 10G Base-T and 10-100 Gbps fiber Ethernet physical layer (PHY) and media access control (MAC) layers. Unless indicated otherwise, features described in connection with the compact network cyber device 10 may also apply to the device 810. An MCM 888 of the MCM package 812 may comprise RON-side 10G Base-T PHY circuitry 875, RON-side 10G-100G/KR4 PHY circuitry 883, a DSP array 871, PLL circuitry 884, an integrated oscillator 890, an integrated power regulator 891, host-side 10G Base-T PHY circuitry 874, and host-side 10G-100G/KR4 PHY circuitry 883. The MCM package 812 may comprise a RON-side connection substrate 896 having a plurality of conductors 897, as well as a host-side connection substrate 898 having a plurality of conductors 899. Although not shown in FIG. 8, the MCM package 812 may also comprise a wireless interface chip (either integrated into the MCM 888 or as a separate chip/chiplet) to perform operations described in connection with the wireless interface 15. A wireless interface of the MCM package 812 may comprise an analog RF interface physically connected to an analog interface of an ADC/DAC block (not shown in FIG. 8) similar to the ADC/DAC 772, and/or may comprise a wireless controller that supports wireless communications according to one or more IEEE 802.11, Bluetooth, and/or other standards and that can be external to the MCM package 812 or internal as described in FIG. 7, the monolithic package 712.

The RON-side conductors 897 may be connected to a transceiver for sending and receiving electrical signals via the RON (not shown). Alternatively, and as shown in FIG. 8, the RON-side conductors 897 may be connected to a transceiver for sending and receiving optical signals via the RON. As shown in FIG. 8, that transceiver may be an ultracompact optical/electrical converter transceiver 889. A switch 895 may connect the RON-side conductors 897 to the PHY circuitry 883 if an optical signal transceiver is connected to the RON-side conductors 897, or to the PHY circuitry 875 if an electrical signal transceiver is connected to the RON-side conductors 897. In the example of FIG. 8, a RON-side connector 814 may comprise the RON-side substrate 896/conductors 897, the transceiver 889, and/or connectors (not shown) to connect the transceiver 889 to optical fibers of an optical data cable. One or more heat pipes and/or other heat conduction paths may be included in the MCM package 812.

The conductors 899 of the host-side substrate 898 may be connected (e.g., by soldering, via an edge connector) to a circuit board or other component of a host network device. The host network device may power the device 810. A switch 894 of the MCM package 812 may alternately connect the conductors 899 to the PHY circuitry 874 or to the PHY circuitry 873. In the example of FIG. 8, a host-side connector 813 may comprise the host-side substrate 898/conductors 899 and/or other connectors (not shown) that connect device 810 to a circuit board or other component of the host network device. As further shown in FIG. 8, the device 810 may comprise, in addition to (or instead of) the oscillator 890 and power regulator 891, an oscillator 892 and power regulator 893.

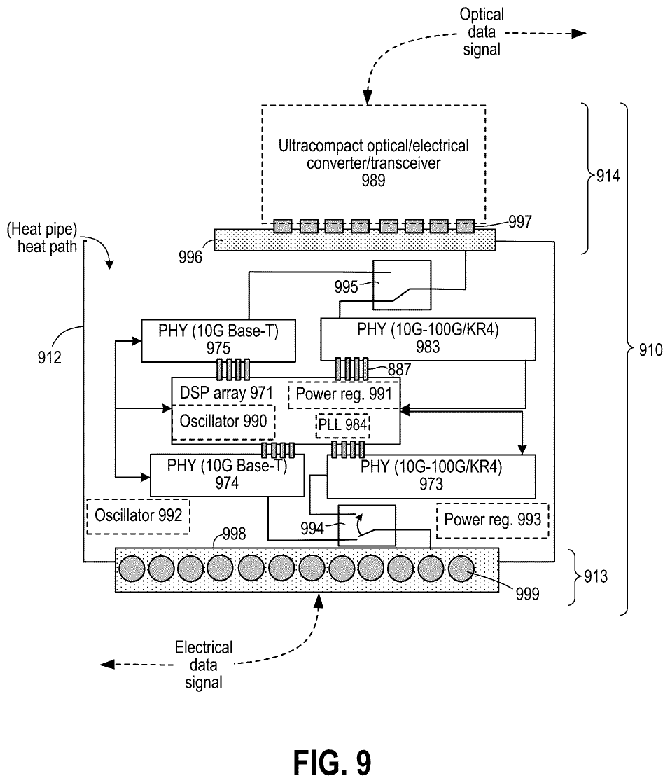

FIG. 9 is a block diagram showing an example compact network cyber device 910 that comprises a stacked MCM package 912, and that also has the ability to switch between 10G Base-T and 10-100 Gbps fiber Ethernet physical layer (PHY) and media access control (MAC) layers. Unless indicated otherwise, features described in connection with the compact network cyber device 10 may also apply to the device 910. The MCM package 912 may comprise stacked chips that include a RON-side 10G Base-T PHY circuitry chip 975, RON-side 10G-100G/KR4 PHY circuitry chip 983, a DSP array chip 971 (comprising integrated PLL circuitry 984, an integrated oscillator 990, and an integrated power regulator 991), a host-side 10G Base-T PHY circuitry chip 974, and a host-side 10G-100G/KR4 PHY circuitry chip 983. The stacked chips may be connected by intersilicon vias 887 and/or using other connections. The MCM package 912 may comprise a RON-side connection substrate 996 having a plurality of conductors 997, as well as a host-side connection substrate 998 having a plurality of conductors 999. Although not shown in FIG. 9, the MCM package 912 may also comprise a wireless interface chip to perform operations described in connection with the wireless interface 15.

The RON-side conductors 997 may be connected to a transceiver for sending and receiving electrical signals via the RON (not shown). Alternatively, and as shown in FIG. 9, the RON-side conductors 997 may be connected to a chip scale transceiver 989 (similar to the transceiver 889), that may be smaller (e.g. length, width, and height) than the size of the chip, for sending and receiving optical signals via the RON. A switch 995 may connect the RON-side conductors 997 to the PHY circuitry 983 if an optical signal transceiver is connected to the RON-side conductors 997, or to the PHY circuitry 975 if an electrical signal transceiver is connected to the RON-side conductors 997. In the example of FIG. 9, a RON-side connector 914 may comprise the RON-side substrate 996/conductors 997, the chip scale transceiver 989, and/or connectors (not shown) to connect the chip scale transceiver 989 to optical fibers of an optical data cable. One or more heat pipes and/or other heat conduction paths may be included in the MCM package 912.

The conductors 999 of the host-side substrate 998 may be connected (e.g., by soldering, via an edge connector) to a circuit board or other component of a host network device. The host network device may power the device 910. A switch 994 of the MCM package 912 may alternately connect the conductors 999 to the PHY circuitry 974 or to the PHY circuitry 973. In the example of FIG. 9, a host-side connector 913 may comprise the host-side substrate 998/conductors 999 and/or other connectors (not shown) that connect the device 910 to a circuit board or other component of the host network device. As further shown in FIG. 9, the device 910 may comprise, in addition to (or instead of) the oscillator 990 and power regulator 991, an oscillator 992 and power regulator 993.

FIG. 10A shows an example compact network cyber device 1010 configured for use with optical data cables, and further configured for installation into a standardized slot of a host network device. Unless indicated otherwise, features described in connection with the compact network cyber device 10 may also apply to the device 1010.

In the example of FIG. 10A, a host network device 1001 (e.g., a network switch, router, firewall, or other network device) comprises eight standardized receptacles 1003a through 1003h that are exposed on a back panel 1002 of the host network device 1001. Each of the receptacles 1003 may be configured to receive a pluggable transceiver module that receives data from the device 1001, converts that data to an optical signal, and transmits that optical signal via an optical cable, and/or that receives data as an optical signal via the optical cable, converts that optical signal to data in electrical form, and forwards that electrical-form data to the device 1001. Mechanical, electrical, and optical requirements for such pluggable transceiver modules, for host device slots configured to receive transceiver modules, for electrical and mechanical interfaces between such modules and a host device, and for mechanical and optical interfaces between such modules and an optical cable, are defined by standards such as the QSFP-DD/QSFP-DD800/QSFP112 Hardware Specification for QSFP Double Density 8× and QSFP 4× Pluggable Transceivers, Rev. 6.3 (Jul. 26, 2022), published by the Quad Small Form-factor Pluggable Double Density Multi-Source Agreement (QSFP-DD MSA), the SFP-DD/SFP-DD112/SFP112 Hardware Specification for SFP112 AND SFP Double Density Pluggable Transceiver, Rev. 5.1 (Mar. 11, 2022) published by the Small Form-factor Pluggable Double Density Multi-Source Agreement (SFP-DD MSA), and/or other standards. A compact network cyber devices in the form of a CQFSP device may, for example, have a size, weight, power, and hardware interface of a QSFP pluggable module and may be configured to carry out, in addition to operations described herein, the operations of a QSFP pluggable module (e.g., function as a port of the device 1001). A compact network cyber device in the form of a CFSP device may, for example, have a size, weight, power, and hardware interface of an SFP pluggable module and may be configured to carry out, in addition to operations described herein, the operations of an SFP pluggable module (e.g., function as a port of the device 1001).

The device 1010 may have a housing 1011 that is configured to fit within any of the receptacles 1003a through 1003h. As shown in FIG. 10A with a broken line, the device 1010 is being inserted into the receptacle 1003a and will rest within inside walls 1004 of an internal cage associated with the receptacle 1003a. The dimensions of the housing 1011 may conform to dimensions defined by the above-mentioned standards. The material of the housing 1011 may be non-metallic to facilitate better communication via the wireless interface 15. Also, or alternatively, the housing 1011 may be formed from a metal (and/or comprise metallic portions) and be used as an antenna of the wireless interface 15.

A host-side connector 1013 of the device 1010 may comprise an edge connector having a substrate with upper and lower surfaces. Conductive traces on both the upper and lower surfaces may be configured to connect, upon installation into a receptacle of a host device, to corresponding conductive elements in a host device mating connector corresponding to the receptacle. A set of RON-side connectors 1014 of the device 1010 may be configured to connect to optical connectors of a cable and may comprise O/E interfaces. For convenience, and because the number of optical connectors that will be present will depend on the type (e.g., supported Ethernet speed) of pluggable module on which the size and hardware interfaces of the device 1010 are based, connectors 1014 are shown as a broken line box. For example, for a CSFP device (SFP (LC duplex)), connectors 1014 may comprise 2 connectors. For a CQFSP device (QFSP (MPO-12, MTP-12)), connectors 1014 may comprise 12 connectors (although 4 may be unused).

FIG. 10B is a diagram showing additional details of the compact network cyber device 1010 after installation into the receptacle 1003a of the host network device 1001. FIG. 10B is a plan view looking down on the top of the device 1010, with top portions of the housing 1011 and the cage associated with the receptacle 1003a omitted, but with an outline of the housing 1011 indicated with small broken lines and outlines of the walls 1004 of the receptacle 1003a cage indicated with larger broken lines. That cage may be mounted to a printed circuit board 1008 of the host device 1001. A host connector 1005, which may also be mounted to the printed circuit board 1008, mates to and connects with the host-side connector 1013 of the device 1010. As also shown in FIG. 10B, an optical connector 1007 of an optical data cable 1006 has been connected to the RON-side connector 1014 of the device 1010. A substrate 1099 of the device 1010, indicated with stippling, may comprise a printed circuit board on which the host-side connector 1013, the processor 1012, the RON-side connector 1014, and the wireless interface 15 are mounted. Conductive traces 1098 on the substrate 1099 may communicatively connect the host-side connector 1013 and the processor 1012. Conductive traces 1097 on the substrate 1099 may communicatively connect the wireless interface 15 and the processor 1012. Conductive traces 1096 on the substrate 1099 may communicatively connect the processor 1012 and the RON-side connector 1014.

The compact network cyber device 1010 may receive electrical power, via the host connector 1005, from the host network device 1001. For example, electrical power received from the host network device 1001 may power the processor 1012, the RON-side connector 1014, the wireless interface 15, and/or other components of the device 1010. The device 1010 may, in addition to being configured to perform operations described herein, be configured to function as port and/or transceiver of the host network device 1001. A compact network cyber device similar to the device 1010 may alternatively comprise an electrical RON-side connector configured to connect to a connector (e.g., an RJ45 connector) of a copper data cable.

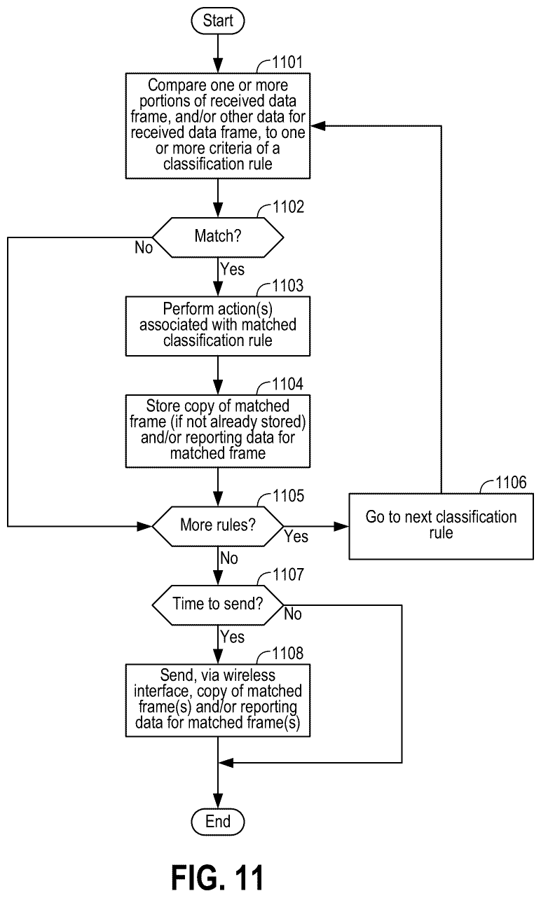

FIG. 11 is a flow chart showing an example method for processing a received data frame. The example method of claim 11 may be performed for every received data frame. For convenience, the example method of FIG. 11 will be described by reference to the device 10. The example method of FIG. 11 may be performed, based on execution of stored instructions, by the processor 12 (and/or other components) of the device 10 and/or by processor(s) (and/or other components) of any of the other compact network cyber devices described herein. One or more steps of the example method may be rearranged (e.g., performed in a different order), omitted, and/or otherwise modified, and/or other steps added.

In step 1101, the device 10 may compare one or more portions of the received data frame to one or more criteria of a classification rule. The one or more portions of the received data frame may comprise one or more Ethernet frame header fields, one or more other fields (e.g., one or more 5-tuple fields or other fields of an IP packet contained in the received data frame), and/or other portions of the received frame. Also, or alternatively, step 1101 may comprising comparing other data (e.g., metadata) for the received data frame to the one or more criteria of the classification rule. Such other data may, for example, comprise a time and/or date associated with the received data frame (e.g., a time and/or date when the data frame was received by the device 10).

In step 1102, the device 10 may determine if the comparing of step 1101 resulted in a match to the classification rule. A match may occur, for a classification rule with a single criterion, if a value from a compared portion of the received frame (or from other data for the received frame) is the same as, or is within a range specified by, the criterion of the rule. A match may occur, for a classification rule with multiple criteria, if values from one or more compared portions of the received frame (and/or from other data for the received frame) are the same as, or are within range(s) specified by, the criteria of the rule. If no match is determined, step 1105 (reached via the “No” branch) may be performed. Step 1105 is described below. If a match is determined, step 1103 (reached via the “Yes”) branch may be performed.

In step 1103, the device 10 may, based on the match determined in step 1102, perform one or more actions comprised, indicated by, or otherwise associated with the matched classification rule. The one or more actions may comprise any of the actions described herein (e.g., any of the actions described in Table 1).

In step 1104, and based on the match determined in step 1102, the device 10 may store a copy of the received data frame. If a copy of the received data frame has already been stored (e.g., in connection with a previous iteration of steps 1101, 1102, and 1103 based on another classification rule), the device 10 may not store another copy of the received frame. Also, or alternatively, step 1104 may comprise storing, based on the match determined in step 1104, reporting data for the received data frame. The reporting data may, for example, comprise a time and/or date of the received date frame, an indication of the matched classification rule, action(s) taken (or to be taken) based on the match, and/or other data.

In step 1105, the device 10 may determine if there are more classification rules to be applied to the received data frame. If yes, step 1106 (reached via the “Yes” branch) may be performed. In step 1106, the device 10 may select the next classification rule for processing in a new iteration of step 1101. Based on performing step 1106, step 1101 may be repeated. If the device 10 determines in step 1105 that there are no more classification rules to be applied to the received data frame, step 1107 (reached via the “No” branch) may be performed. In step 1107, the device 10 may determine if it is time to send, via the wireless interface 15, copies of matching data frames and/or other reporting data for those matching data frames. For example, to minimize power consumption and/or performance of the device 10, and/or to make the device 10 less detectable, the device 10 may be configured to transmit copies of matching frames, reporting data, and/or other data at predetermined times (e.g., times associated with low activity in the monitored network, times when an office associated with the device 10 may be closed, etc.).

If the device 10 determines in step 1107 that it is time to send copies of matching data frames and/or reporting data for matching data frames that have been stored in memory during one or more iterations of step 1104, step 1108 (reached via the “Yes” branch) may be performed. In step 1108, the stored copies of matching data frames and/or reporting data may be transmitted, via the wireless interface 15, to the management software 34. The data transmitted in step 1108 may also or alternatively comprise traffic analysis data (e.g., generated based on Al/ML as described herein) and/or other network data collected and/or generated by the device 10. If the device 10 determines in step 1107 that it is not time to send copies of matching data frames and/or reporting data for matching data frames that have been stored in memory, the example method of FIG. 11 may end (via the “No” branch). Also, or alternatively, a separate process, not shown in FIG. 11 but running in parallel with the method of FIG. 11, may be configured to determine if it is time to send, via the wireless interface 15, copies of matching data frames and/or other reporting data for those matching data frames, and to cause such copies and/or reporting data to be sent if it is time to send. Also, or alternatively, the device 10 may be configured to send, via the wireless interface 15 and in response to a request (e.g., from the management software 34) received via the wireless interface, copies of matching data frames and/or other reporting data for those matching data frames.

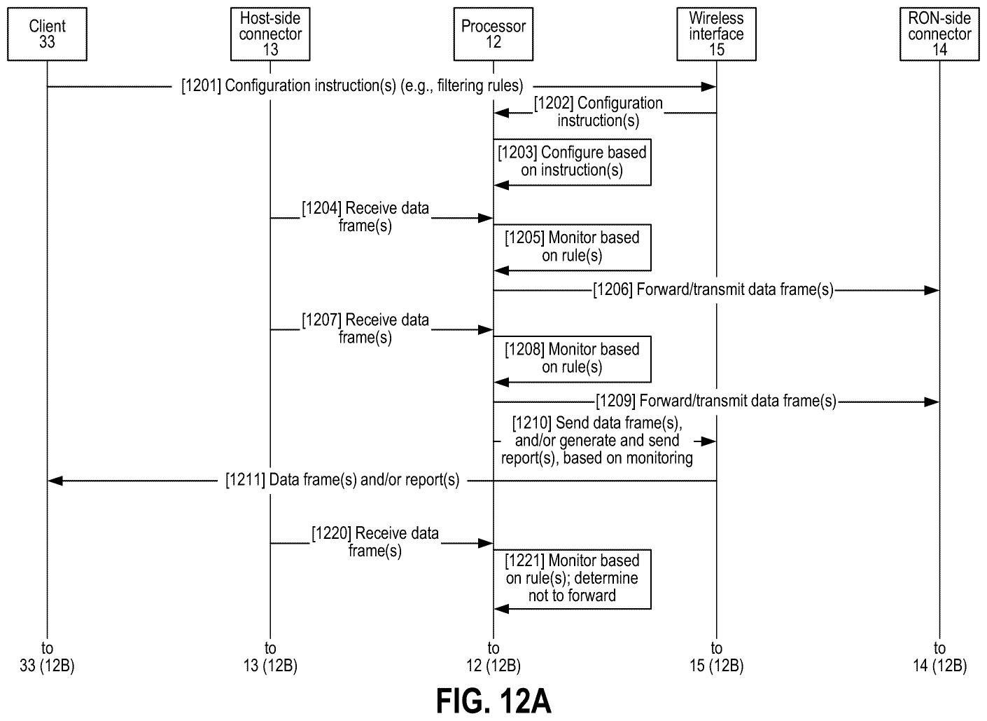

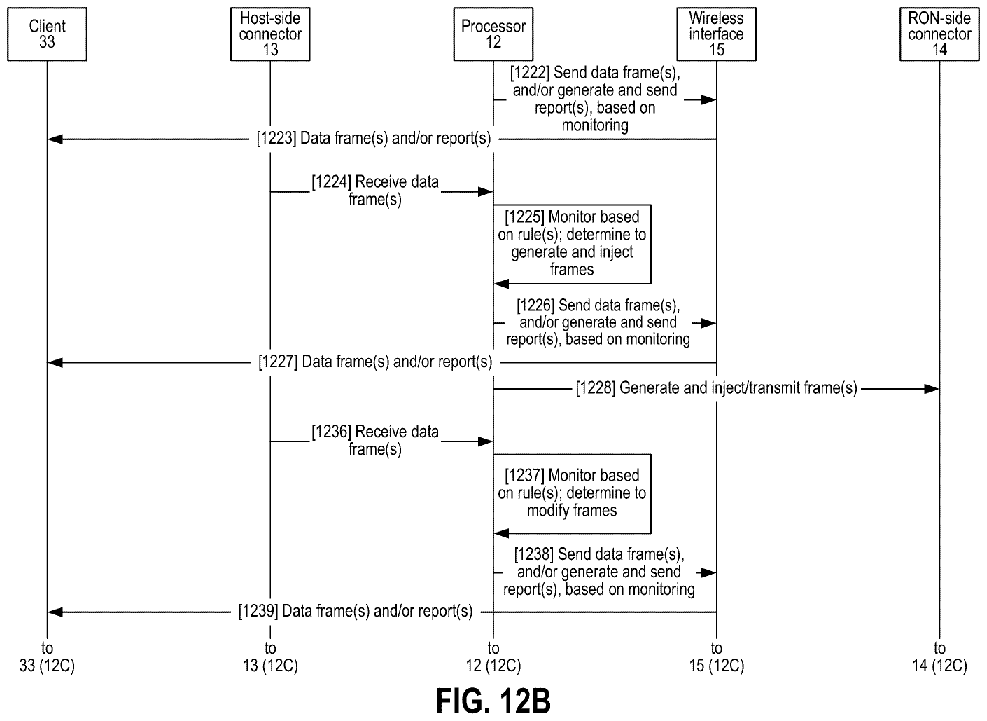

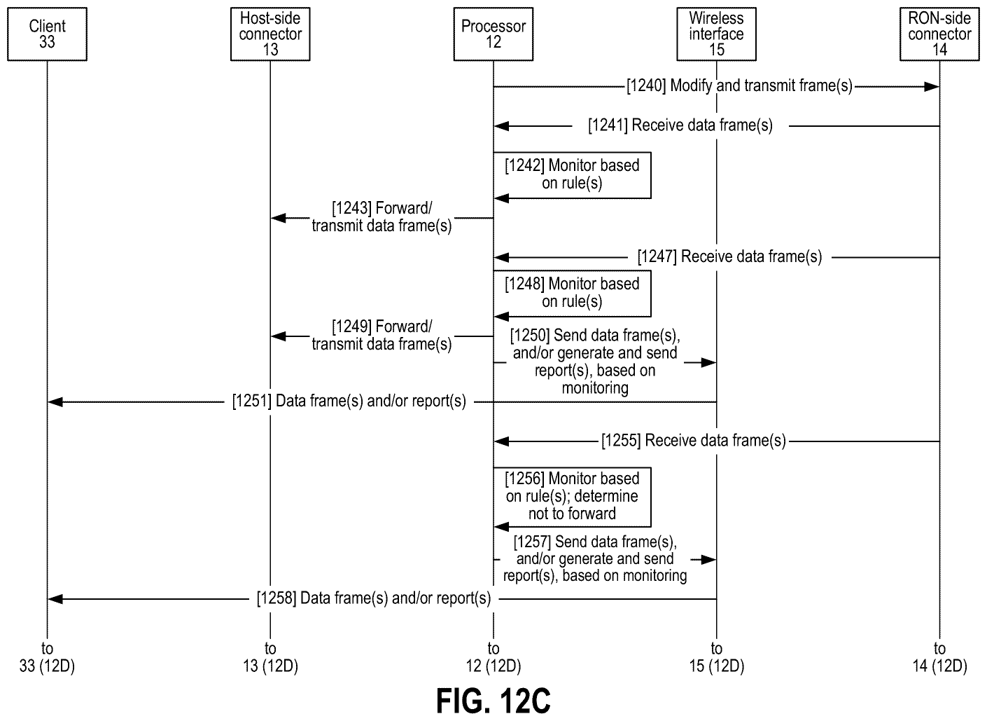

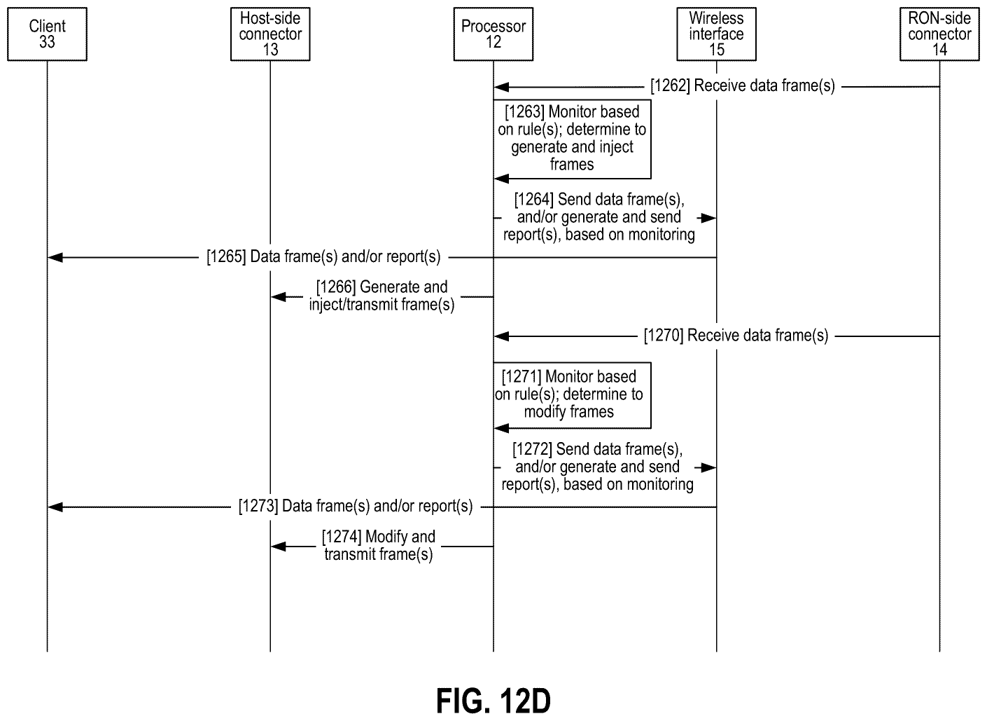

FIGS. 12A through 12D are a sequence diagram shows operations that may be performed by a compact network cyber device. That device may be performing the method of FIG. 11. For convenience, the examples of FIGS. 12A through 12D are described by reference to the compact network cyber device 10 and its components. However, the operations shown in FIGS. 12A through 12D may be performed by any of the compact network cyber devices described herein, and thus FIGS. 12A through 12D are representative of operations that may be performed by any of the compact network cyber devices described herein. One or more of the operations shown in the sequence diagram of FIGS. 12A through 12D may be repeated, combined, modified, performed in other orders, and/or omitted.

In step 1201, the management software 34 executing on the client computing device 33 may send, to the wireless interface 15, data comprising one or more configuration instructions. The configuration instructions may comprise one or more compiled classification rules. Each of the classification rules may comprise, indicate, or otherwise be associated with one or more actions to be performed based on a frame matching one or more criteria of the rule. The criteria of the classification rules may comprise Layer 2 criteria (e.g., for MAC/Ethernet) and/or criteria for Layer 3 (e.g., for IP packet fields). Also, or alternatively, the configuration instructions may be directed to configuration of other operations of the device 10 (e.g., configuration of one or more Ethernet interfaces, configuration of a sleep/wake time period for communications via the wireless interface 15, etc.). In step 1202, the processor 12 may receive the configuration instructions, sent in step 1201, from the wireless interface 15. In step 1203, the processor 12 may perform one or more configuration operations based on the instructions from step 1202. The operations of step 1203 may comprise loading classification rules and/or other configuring operations.

In step 1204, the processor 12 may receive, via the host-side connector 13, one or more data frames (e.g., Ethernet frames). In step 1205, the processor 12 may monitor, based on one or more stored classification rules, the data frames received in step 1204. Monitoring may comprise comparing the received frames or portions thereof to the stored classification rules (e.g., step 1101 of FIG. 11) and determining if any L2 or L3 data of the received frames (e.g., Ethernet header values, IP header values, and/or other data) matches one or more criteria for any of the classification rules (e.g., step 1102 of FIG. 11). In the present example, none of the data frames received in step 1204 match any stored rules. In step 1206, the processor 12 may cause the data frames received in step 1204 to be transmitted via the RON-side connector 14.

In step 1207, the processor 12 may receive, via the host-side connector 13, one or more data frames (e.g., Ethernet frames). In step 1208, the processor 12 may monitor, based on one or more stored classification rules, the data frames received in step 1207. In the present example, one or more of the data frames received in step 1207 match one or more stored rules, but none of the matched rules is associated with an action that prevents forwarding the matching data frames. In step 1209, the processor 12 may cause the data frames received in step 1207 to be transmitted via the RON-side connector 14. In step 1210, the processor 12 may send, to the wireless interface 15, copies of the data frames that were determined in step 1208 to match one or more classification rules. In step 1210 the processor 12 may also or alternatively send one or more reports or other data associated with those matching data frames. In step 1211, the wireless interface 15 may transmit, to the management software 34 executing on the client 33, the frame copies and/or other data received from the processor 12 in step 1210. Also, or alternatively, the frame copies and/or other data received from the processor 12 in step 1210 may be stored by the device 10 and later transmitted by the wireless interface 15 to the management software 34.

In step 1220, the processor 12 may receive, via the host-side connector 13, one or more data frames (e.g., Ethernet frames). In step 1221, the processor 12 may monitor, based on one or more stored classification rules, the data frames received in step 1220. In the present example, one or more of the data frames received in step 1220 match one or more stored rules, and the matched one or more rules are associated with an action that prevents forwarding the matching data frames. Accordingly, the processor 12 does not cause the matching data frames to be transmitted via the RON-side connector 14. In step 1222 (FIG. 12B), the processor 12 may send, to the wireless interface 15, copies of the data frames that were determined in step 1221 to match one or more classification rules. In step 1222 the processor 12 may also or alternatively send one or more reports or other data associated with those matching data frames. In step 1223, the wireless interface 15 may transmit, to the management software 34 executing on the client 33, the frame copies and/or other data received from the processor 12 in step 1222. Also, or alternatively, the frame copies and/or other data received from the processor 12 in step 1222 may be stored by the device 10 and later transmitted by the wireless interface 15 to the management software 34.

In step 1224, the processor 12 may receive, via the host-side connector 13, one or more data frames (e.g., Ethernet frames). In step 1225, the processor 12 may process, based on one or more stored classification rules, the data frames received in step 1224. In the present example, one or more of the data frames received in step 1224 match one or more stored rules, and the matched one or more rules are associated with an action that specifies generating one or more data frames and inserting those generated one or more data frames into the data stream. In step 1226, the processor 12 may send, to the wireless interface 15, copies of the data frames that were determined in step 1225 to match one or more classification rules. In step 1226 the processor 12 may also or alternatively send one or more reports or other data associated with those matching data frames. In step 1227, the wireless interface 15 may transmit, to the management software 34 executing on the client 33, the frame copies and/or other data received from the processor 12 in step 1226. Also, or alternatively, the frame copies and/or other data received from the processor 12 in step 1226 may be stored by the device 10 and later transmitted by the wireless interface 15 to the management software 34. In step 1228, the processor 12 may generate data frames and may cause those generated data frames to be transmitted via the RON-side connector 14. The device 10 may store one or more templates for use in generating data frames, and step 1228 may comprise determining one or more templates (e.g., based on the classification rule(s) determined in step 1225 to be matched) and generating frame(s) based on the determined template(s). The generated data frames may replace (e.g., may be sent instead of) data frames determined in step 1225 to match one or more classification rules. Alternatively, one or more of the matching data frames may be sent in addition to the generated data frames.

In step 1236, the processor 12 may receive, via the host-side connector 13, one or more data frames (e.g., Ethernet frames). In step 1237, the processor 12 may monitor, based on one or more stored classification rules, the data frames received in step 1236. In the present example, one or more of the data frames received in step 1236 match one or more stored rules, and the matched one or more rules are associated with an action that specifies modifying one or more matching data frames before forwarding those data frames from the device 10. In step 1238, the processor 12 may send, to the wireless interface 15, copies of the data frames that were determined in step 1236 to match one or more classification rules. In step 1238 the processor 12 may also or alternatively send one or more reports or other data associated with those matching data frames. In step 1239, the wireless interface 15 may transmit, to the management software 34 executing on the client 33, the frame copies and/or other data received from the processor 12 in step 1238. Also, or alternatively, the frame copies and/or other data received from the processor 12 in step 1238 may be stored by the device 10 and later transmitted by the wireless interface 15 to the management software 34. In step 1240 (FIG. 12C), the processor 12 may modify one or more of the matching data frames and may cause those modified data frames to be transmitted via the RON-side connector 14.

Steps 1241, 1242, and 1243 may be respectively similar to steps 1204, 1205, and 1206, except that the flow of data frames is in the other direction. In other words, data frames are received from the RON-side connector 14 and caused to be transmitted via the host-side connector 13.

Steps 1247, 1248, 1249, 1250, and 1251 may be respectively similar to steps 1207, 1208, 1209, 1210, and 1211, except that in step 1247 data frames are received from the RON-side connector 14 (instead of from the host-side connector 13 as in step 1207), and in step 1249 the processor 12 causes the data frames to be transmitted via the host-side connector 13 (instead of via the RON-side connector 14 as in step 1209). Steps 1255, 1256, 1257, and 1258 may be respectively similar to steps 1220, 1221, 1222, and 1223, except that in step 1255 data frames are received from the RON-side connector 14 (instead of from the host-side connector 13 as in step 1220).

Steps 1262, 1263, 1264, 1265, and 1266 (FIG. 12D) may be respectively similar to steps 1224, 1225, 1226, 1227, and 1228, except that in step 1262 data frames are received from the RON-side connector 14 (instead of from the host-side connector 13 as in step 1224), and in step 1266 the processor 12 causes the generated data frames to be transmitted via the host-side connector 13 (instead of via the RON-side connector 14 as in step 1228). Steps 1270, 1271, 1272, 1273, and 1274 may be respectively similar to steps 1236, 1237, 1238, 1239, and 1240, except that in step 1270 data frames are received from the RON-side connector 14 (instead of from the host-side connector 13 as in step 1236), and in step 1274 the processor 12 causes the modified data frames to be transmitted via the host-side connector 13 (instead of via the RON-side connector 14 as in step 1240).

In performing operations such as those described in connection with FIGS. 12A through 12D, the device 10 may receive (e.g., via the host-side connector 13 or the RON-side connector 14) a data stream comprising multiple data frames, and may take different actions with regard to different frames in that data stream. For example, some data frames of that data stream may not match a stored classification rule and may be transmitted from the device 10 to the network (e.g., via the other of the connector 13 or connector 14) without further action. Also, or alternatively, some data frames of that data stream may match a stored classification rule and may be transmitted from the device 10 to the network (e.g., via the other of the connector 13 or connector 14), but the device 10 may (e.g., based on an action specified by the matched rule) cause copies of the matching data frames and/or other data to be stored and/or transmitted to the management software 34 executing on the client device 33. Also, or alternatively, some data frames of that data stream may match a stored classification rule, but the device 10 may (e.g., based on an action specified by the matched rule) prevent the matching data frames from being transmitted to the network and/or may cause copies of the matching data frames and/or other data to be stored and/or transmitted to the management software 34 executing on the client device 33. Also or alternatively, some data frames of that data stream may match a stored classification rule, and the device 10 may (e.g., based on an action specified by the matched rule) generate one or more additional data frames and cause those generated data frames to be transmitted (with or without the matching data frames) from the device 10 to the network (e.g., via the other of the connector 13 or connector 14), and may cause copies of the matching data frames and/or other data to be stored and/or transmitted to the management software 34 executing on the client device 33. Also or alternatively, some data frames of that data stream may match a stored classification rule, and the device 10 may (e.g., based on an action specified by the matched rule) modify one or more of those data frames and cause those modified data frames to be transmitted from the device 10 to the network (e.g., via the other of the connector 13 or connector 14), and may cause copies of the matching data frames and/or other data to be stored and/or transmitted to the management software 34 executing on the client device 33. Also or alternatively, some data frames of that data stream may match a stored classification rule, and the device 10 may (e.g., based on an action specified by the matched rule) cause one or more AI/ML algorithms (and/or other algorithms) to be applied to those matching data frames and generate analysis data, cause those matching data frames to be blocked or be transmitted from the device 10 to the network (e.g., via the other of the connector 13 or connector 14), and may cause copies of the matching data frames and/or the analysis data to be stored and/or transmitted to the management software 34 executing on the client device 33.

As can be appreciated from the foregoing disclosure, the compact network cyber devices described herein may be small in size, may have low power requirements, and may be economically produced. The compact network cyber devices described herein may have hardware components that can be integrated into a chip package such as a MCM, a SiP, a SoC, and/or a monolithic integrated circuit interconnected by one or more substrates. One or more of these characteristics facilitate installation of one more such compact network cyber devices in one or more locations of an enterprise network. Such installations may be unobtrusive and, if desired, concealed. Installation of multiple compact network cyber devices may facilitate monitoring and controlling an enterprise network from multiple different locations, thereby increasing network security and reliability. For example, a compact network cyber device may comprise a pluggable transceiver. For example, such devices may be configured for installation as pluggable transceiver modules (e.g., QSFP or SFP modules) and configured to perform, in addition to operations of conventional pluggable transceiver modules, operations such as those described herein for the compact network cyber device 10 and/or other compact network cyber devices described herein.

Although certain example components and/or commercially available components are provided above as examples, other components may be used. For example, a processor may comprise a DSP array having an architecture other than as shown in FIG. 4, and/or may have an architecture other than a DSP array.

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, sub-combinations, and permutations of structure, operations, and/or other features described herein and in the accompanying drawing figures.

1. A network cyber device comprising:
a host connector configured to physically and electrically mate with a connector mounted to a circuit board of a host network device;
a network cable connector configured to connect to a mating connector of a data cable;
a wireless interface configured to send and receive data via wireless communications;
one or more processors; and
memory storing instructions that, when executed by the one or more processors, configure the network cyber device to:
receive, via the host connector or the network cable connector, data frames communicated via a network;
determine, for one or more of the received data frames and based on comparison to one or more criteria of one or more classification rules, one or more matches to criteria of one or more matched rules of the one or more classification rules;
transmit, via the other of the host connector or the network cable connector, at least a portion of the received data frames; and
transmit, via the wireless interface, one or more of:
copies of the one or more of the received data frames, or
data based on the one or more of the received data frames.

2. The network cyber device of claim 1, wherein the instructions, when executed by the one or more processors, configure the network cyber device to:
perform, based on the one or more matches, and for the one or more of the received data frames, one or more actions indicated by the matched rules, wherein the one or more actions comprise one or more of:
forwarding a received data frame,
blocking a received data frame,
modifying a received data frame and forwarding the modified received data frame, or
generating a data frame and forwarding the generated data frame.

3. The network cyber device of claim 1, further comprising a device housing containing the wireless interface, the one or more processors, and the memory, wherein the device housing is configured to fit within a receptacle of the host network device that is configured to receive a small form-factor pluggable transceiver module, and wherein the host connector comprises an edge connector configured to physically and electrically mate with a connector mounted to a circuit board of the host network device.

4. The network monitoring device of claim 1, wherein the host network device comprises a network switch, a router, or a firewall.

5. The network cyber device of claim 1, wherein the network cable connector comprises an optical cable connector, and wherein the network cyber device further comprises an optical/electrical converter configured to convert between electrical data signals and optical data signals.

6. The network cyber device of claim 1, wherein the network cyber device is configured to receive electrical power from the host network device via the connector mounted to a circuit board of the host network device.

7. The network cyber device of claim 1, wherein the instructions, when executed by the one or more processors, configure the network cyber device to generate and transmit data frames via at least one of the host connector or the network cable connector.

8. The network cyber device of claim 1, wherein the instructions, when executed by the one or more processors, configure the network cyber device to receive, via the wireless interface, instructions comprising the one or more classification rules.

9. The network cyber device of claim 1, wherein the instructions, when executed by the one or more processors, configure the network cyber device to receive, via the wireless interface, instructions comprising one or more of network interface configuration instructions or sleep/wake configuration instructions associated with the wireless interface.

10. The network cyber device of claim 1, wherein the network comprises an Ethernet network and the data frames comprise Ethernet frames.

11. The network cyber device of claim 1, wherein the wireless interface comprises one or more of an IEEE 802.11 wireless interface or a BLUETOOTH wireless interface.

12. The network cyber device of claim 1, wherein the one or more processors and the memory comprise one or more of a system on a chip or a multichip module.

13. The network cyber device of claim 1, wherein the host network device comprises a network switch, and wherein the instructions, when executed by the one or more processors, configure the network cyber device to operate as a port of the network switch.

14. A network cyber device comprising:
a host connector configured to physically and electrically mate with a connector of a host network device, and wherein the network cyber device is configured to receive electrical power from the host network device via the connector of the host network device;
a network cable connector configured to connect to a mating connector of a data cable;
a wireless interface configured to send and receive data via wireless communications;
one or more processors; and
memory storing instructions that, when executed by the one or more processors, configure the network cyber device to:
receive, via the host connector or the network cable connector, data frames communicated via a network;
compare at least portions of the received data frames to one or more criteria of one or more classification rules;
transmit, via the other of the host connector or the network cable connector, one or more of the received data frames; and
transmit, via the wireless interface, data based on the comparison of the at least the portions of the received data frames to the one or more criteria of the one or more classification rules.

15. The network cyber device of claim 14, wherein the instructions, when executed by the one or more processors, configure the network monitoring device to:
perform, based on one or more matches to the one or more criteria, and for one or more of the received data frames associated with the one or more matches, one or more actions indicated by rules, of the one or more classification rules, associated with the matched one or more criteria, wherein the one or more actions comprise one or more of:
forwarding a received data frame,
blocking a received data frame,
modifying a received data frame and forwarding the modified received data frame, or
generating a data frame and forwarding the generated data frame.

16. The network cyber device of claim 14, further comprising a device housing containing the wireless interface, the one or more processors, and the memory, wherein the device housing is configured to fit within a receptacle of the host network device that is configured to receive a small form-factor pluggable transceiver module, and wherein the host connector comprises an edge connector configured to physically and electrically mate with a connector mounted to a circuit board of the host network device.

17. The network cyber device of claim 14, wherein the host network device comprises a network switch, a router, or a firewall, wherein the network cable connector comprises an optical cable connector, and wherein the network cyber device further comprises an optical/electrical converter configured to convert between electrical data signals and optical data signals.

18. A network cyber device comprising:
a host connector configured to physically and electrically mate with a connector of a host network device;
an optical cable connector configured to connect to a mating connector of an optical data cable;
an optical/electrical converter configured to convert between optical data signals, communicated via the optical data cable, and electrical data signals;
a wireless interface configured to send and receive data via wireless communications;
one or more processors; and
memory storing instructions that, when executed by the one or more processors, configure the network cyber device to:
receive, via the host connector or the optical cable connector, data frames communicated via a network;
compare at least portions of the received data frames to one or more criteria of one or more classification rules;
transmit, via the other of the host connector or the optical cable connector, one or more of the received data frames; and
transmit, via the wireless interface, data based on the comparison of the at least the portions of the received data frames to the one or more criteria of the one or more classification rules.

19. The network cyber device of claim 18, wherein the instructions, when executed by the one or more processors, configure the network monitoring device to:
perform, based on one or more matches to the one or more criteria, and for one or more of the received data frames associated with the one or more matches, one or more actions indicated by rules, of the one or more classification rules, associated with the matched one or more criteria, wherein the one or more actions comprise one or more of:
forwarding a received data frame,
blocking a received data frame,
modifying a received data frame and forwarding the modified received data frame, or
generating a data frame and forwarding the generated data frame.

20. The network cyber device of claim 18, further comprising a device housing containing the wireless interface, the one or more processors, and the memory, wherein the device housing is configured to fit within a receptacle of the host network device that is configured to receive a small form-factor pluggable transceiver module, and wherein the host connector comprises an edge connector configured to physically and electrically mate with a connector mounted to a circuit board of the host network device.
